(19) United States
(12) Patent Application Publication
(10) Pub. No.: US 2023/0084460 A1
(43) Pub. Date: Mar. 16, 2023

(54) CSI FEEDBACK FOR NON-COHERENT JOINT TRANSMISSION

(71) Applicant: Telefonaktiebolaget LM Ericsson (publ), Stockholm (SE)

(72) Inventors: Shiwei Gao, Nepean (CA); Mattias Frenne, Uppsala (SE); Simon Järmyr, Skarpnäck (SE); Helka-Liina Määttänen, Helsinki (FI); Siva Muruganathan, Stittsville (CA); Andreas Nilsson, Göteborg (SE); Claes Tidestav, Bålsta (SE)

(21) Appl. No.: 17/799,430

(22) PCT Filed: Feb. 11, 2021
(86) PCT No.: PCT/IB2021/051142

§ 371 Date: Aug. 12, 2022

Related U.S. Application Data
(60) Provisional application No. 62/975,839, filed on Feb. 13, 2020.

(51) Int. Cl. H04L 5/00; H04B 7/06

(52) U.S. Cl. CPC H04L 5/0057; H04L 5/0035; H04B 7/0626; H04L 5/0048; H04L 5/0094

(57) ABSTRACT

Systems and methods are disclosed herein for Channel State Information (CSI) feedback for Non-Coherent Joint Transmission (NC-JT). In one embodiment, a method performed by a wireless communication device comprises receiving a CSI report configuration that comprises either: a first group of Non-Zero Power CSI reference signal (NZP CSI-RS) resources for channel measurement and a second group of NZP CSI-RS resources for channel measurement or a list of NZP CSI-RS resource tuples each comprising one or more NZP CSI-RS resources for channel measurement. The method further comprises selecting a first NZP CSI-RS resource and/or a second NZP CSI-RS resources in the first group of NZP CSI-RS resources and/or the second group of NZP CSI-RS resources, respectively, or in a NZP CSI-RS resource tuple in the list of NZP CSI-RS resource tuples. The method further comprises reporting, to a network node, CSI based on the first and/or second NZP CSI-RS resources.

### RELATED APPLICATIONS

This application claims the benefit of provisional patent application Ser. No. 62/975,839, filed Feb. 13, 2020, the disclosure of which is hereby incorporated herein by reference in its entirety.

### TECHNICAL FIELD

The present disclosure is related to Channel State Information (CSI) reporting in a wireless network.

### BACKGROUND

The next generation mobile wireless communication system (5G) or new radio (NR) will support a diverse set of use cases and a diverse set of deployment scenarios. The later includes deployment at both low frequencies (below 6 Gigahertz (GHz)) and very high frequencies (up to 10's of GHz).

Like in Long Term Evolution (LTE), NR uses Cyclic Prefix Orthogonal Frequency Division Multiplexing (CP-OFDM) in the downlink (i.e., from a network node, NR base station (gNB), evolved Node B (eNB), or base station, to a user equipment (UE)) and both CP-OFDM and Discrete Fourier Transform (DFT)-spread OFDM (DFT-S-OFDM) in the uplink (i.e., from UE to gNB). In the time domain, NR downlink and uplink are organized into equally sized subframes of 1 millisecond (ms) each. A subframe is further divided into multiple slots of equal duration. The slot length depends on subcarrier spacing. For subcarrier spacing of Lf=15 kilohertz (kHz), there is only one slot per subframe and each slot consists of fourteen (14) OFDM symbols.

Data scheduling in NR can be on a slot basis as in LTE. An example of the NR time-domain structure for 15 kHz subcarrier spacing is shown in FIG. 1 with a 14-symbol slot, where the first two symbols contain Physical Downlink Control Channel (PDCCH) and the rest of the symbols contain Physical Data Channel (PDCH), which may be either Physical Downlink Shared Channel (PDSCH) or Physical Uplink Shared Channel (PUSCH).

Different subcarrier spacing values are supported in NR. The supported subcarrier spacing values, which are also referred to as different numerologies, are given by Δf=(15×2^{α}) kHz where α=0, 1, 2, 3, 4. Δf=15 kHz is the basic subcarrier spacing that is also used in LTE.

In the frequency domain, a system bandwidth is divided into resource blocks (RBs), each corresponding to twelve (12) contiguous subcarriers. The RBs are numbered starting with 0 from one end of the system bandwidth. The basic NR physical time-frequency resource grid is illustrated in FIG. 2, where only one RB within a 14-symbol slot is shown. One OFDM subcarrier during one OFDM symbol interval forms one resource element (RE).

Downlink (DL) transmissions are dynamically scheduled, i.e., in each slot, the gNB transmits Downlink Control Information (DCI) over PDCCH about which UE data is to be transmitted to and which RBs in the current downlink slot the data is transmitted on. PDCCH is typically transmitted in the first one or two OFDM symbols in each slot in NR. The UE data downlink transmissions are carried on PDSCH. A UE first detects and decodes PDCCH and, if the decoding is successful, the UE then decodes the corresponding PDSCH based on the decoded DCI in the PDCCH.

Uplink data transmissions are also dynamically scheduled using PDCCH. Similar to downlink, a UE first decodes uplink grants in PDCCH and then transmits data over PUSCH based the decoded control information in the uplink grant such as modulation order, coding rate, uplink resource allocation, etc.

### Beam Management

At millimeter wave (mmW) frequencies, concepts for handling mobility between beams both within and between Transmission/Reception Points (TRPs) have been specified in NR. At these frequencies, where high-gain beamforming is used, each beam is only optimal within a small area, and the link budget outside the optimal beam deteriorates quickly. Hence, frequent and fast beam switching may be needed to maintain high performance. To support such beam switching, a beam indication framework has been specified in NR. For example, for PDSCH transmission, the DCI contains a Transmission Configuration Indicator (TCI) field that informs the UE which beam is used so that the UE can adjust its receive (Rx) beam accordingly. This is beneficial for the case of analog Rx beamforming where the UE needs to determine and apply the Rx beamforming weights before the UE can receive the PDSCH.

In what follows, the terminology “spatial filtering weights” or “spatial filtering configuration” are used to refer to the antenna weights that are applied at either the transmitter (at the gNB for downlink or at the UE for uplink) or the receiver (at UE for downlink or at the gNB for uplink) for data/control transmission/reception. This term is more general in the sense that different propagation environments lead to different spatial filtering weights that match the transmission/reception of a signal to the channel. The spatial filtering weights may not always result in a beam in a strict sense.

Prior to data transmission, a training phase is required in order to determine the gNB and UE spatial filtering configurations. This is illustrated in FIG. 3 and is referred to in NR as downlink (DL) beam management. In NR, two types of reference signals (RSs) are used for DL beam management operations, namely, the Channel State Information RS (CSI-RS) and the Synchronization Signal/Physical Broadcast Control Channel (SS/PBCH) block, or SSB for short. FIG. 3 shows an example where CSI-RS is used to find an appropriate beam pair link (BPL), meaning a suitable gNB transmit spatial filtering configuration (gNB transmit (Tx) beam) plus a suitable UE receive spatial filtering configuration (UE Rx beam) resulting in sufficiently good link budget.

FIG. 3 shows a beam training phase followed by data transmission phase. In the example of FIG. 3, in the gNB Tx beam sweep, the gNB configures the UE to measure on a set of five CSI-RS resources (RS1 . . . RS5) which are transmitted with five different spatial filtering configurations (Tx beams). The UE is also configured to report back the RS identity (ID) and the Reference-Signal Receive Power (RSRP) of the CSI-RS corresponding to the maximum measured RSRP. In this example, the maximum measured RSRP corresponds to RS4. In this way, the gNB learns what is the preferred Tx beam from the UE perspective. In the subsequent UE Rx beam sweep, the gNB transmits a number of CSI-RS resources in different OFDM symbols all with the same spatial filtering configuration (Tx beam) as was used to transmit RS4 previously. The UE then tests a different Rx spatial filtering configuration (Rx beam) in each OFDM symbol in order to maximize the received RSRP. The UE remembers the RS ID (RS ID 4 in this example) and the corresponding spatial filtering configuration that results in the largest RSRP. The network can then refer to this RS ID in the future when DL data is scheduled to the UE, thus allowing the UE to adjust its Rx spatial filtering configuration (Rx beam) to receive the PDSCH. As mentioned above, the RS ID is contained in a TCI that is carried in a field in the DCI that schedules the PDSCH.

For downlink data/control transmission, the gNB indicates to the UE that the PDCCH/PDSCH Demodulation Reference Signal (DMRS) is spatially quasi-co-located (QCL) with RS4—the RS on which the UE performs measurements during the UE beam sweep in the beam training phase in the above example. At least for uplink control channel transmission, the gNB indicates to the UE that RS4 is the reference signal for spatial relation for PUCCH.

### DL CSI Feedback

For DL CSI feedback, NR has adopted an implicit CSI mechanism where a UE feeds back the downlink CSI, which typically includes a transmission rank indicator (RI), a precoder matrix indicator (PMI), and channel quality indicator (CQI) for each codeword. The CQI/RI/PMI report can be either wideband or subband based on CSI report configuration.

The RI corresponds to a recommended number of layers that are to be spatially multiplexed and thus transmitted in parallel in downlink. The PMI identifies a recommended precoding matrix to use to precode one or more layers of a PDSCH signal over multiple antenna ports characterized by a Non-Zero Power (NZP) CSI-RS resource. The CQI represents a recommended modulation level (i.e. Quadrature Phase Shift Keying (QPSK), 16 Quadrature Amplitude Modulation (16QAM), etc.) and coding rate for each codeword. NR supports transmission of one or two codewords to a UE in a slot.

### CSI-RS

For CSI measurement and feedback, CSI-RSs are defined. A CSI-RS is transmitted on each transmit antenna (or antenna port) and is used by a UE to measure the downlink channel between each of the transmit antenna ports and each of its receive antennas. The antenna ports are also referred to as CSI-RS ports. The supported numbers of antenna ports in NR are {1, 2, 4, 8, 12, 16, 24, 32}. By measuring the received CSI-RS, a UE can estimate the downlink channel that the CSI-RS is traversing, including the radio propagation channel and antenna gains. The CSI-RS for the above purpose is also referred to as NZP CSI-RS.

NZP CSI-RS can be configured to be transmitted in certain REs in a slot and certain slots. FIG. 4 shows an example of CSI-RS REs for twelve (12) antenna ports, where 1 RE per RB per port is shown.

In addition, CSI Interference Measurement (CSI-IM) resource is also defined in NR for a UE to measure interference. A CSI-IM resource contains four REs, which may be either four adjacent REs in frequency in the same OFDM symbol or a two-by-two set of adjacent REs in both time and frequency per RB in a slot. By measuring both the downlink channel based on NZP CSI-RS and the interference based on CSI-IM, a UE can estimate the effective channel and noise plus interference to determine the CSI, i.e. rank, precoding matrix, and the channel quality.

### CSI Framework in NR

In NR, a UE can be configured with multiple CSI reporting settings, each represented by a higher layer parameter CSI-ReportConfig with an associated identity ReportConfigID, and multiple CSI resource settings, each represented by a higher layer parameter CSI-ResourceConfig with an associated identity CSI-ResourceConfigId. Each CSI resource setting can contain one or multiple CSI resource sets, each represented by a higher layer parameter NZP-CSI-RS-ResourceSet with an associated identity NZP-CSI-RS-ResourceSetId for channel measurement or by a higher layer parameter CSI-IM-ResourceSet with an associated identity CSI-IM-ResourceSetId for interference measurement. Each NZP CSI-RS resource set for channel measurement can contain up to eight NZP CSI-RS resources. For each CSI reporting setting, a UE feeds back a set of CSIs, which may include one or more of a CSI-RS resource indicator (CRI), a RI, a PMI, and a CQI per codeword, depending on the configured report quantity.

Each Reporting Setting CSI-ReportConfig is associated with a single downlink bandwidth part (BWP) (indicated by higher layer parameter BWP-Id) given in the associated CSI-ResourceConfig for channel measurement and contains the parameter(s) for one CSI reporting band. Each CSI reporting setting may contain the following information:
A CSI resource setting for channel measurement based on NZP CSI-RS resources (represented by a higher layer parameter resourcesForChannelMeasurement),
A CSI resource setting for interference measurement based on CSI-IM resources (represented by a higher layer parameter csi-IM-ResourcesForInterference),
Optionally, a CSI resource setting for interference measurement based on NZP CSI-RS resources (represented by a higher layer parameter nzp-CSI-RS-ResourcesForInterference,
Time-domain behavior, i.e. periodic, semi-persistent, or aperiodic reporting (represented by a higher layer parameter reportConfigType),
Frequency granularity, i.e. wideband or subband,
CSI parameters to be reported such as RI, PMI, CQI, L1-RSRP/L1_SINR and CRI in case of multiple NZP CSI-RS resources in a resource set is used for channel measurement (represented by a higher layer parameter reportQuantity, such as ‘cri-RI-PMI-CQI’ ‘cri-RSRP’, or ‘ssb-Index-RSRP’),
Codebook types, i.e. type I or II if reported, and codebook subset restriction,
Measurement restriction.

For periodic and semi-static CSI reporting, only one NZP CSI-RS resource set can be configured for channel measurement and only one CSI-IM resource set can be configured for interference measurement. For aperiodic CSI reporting, a CSI resource setting for channel measurement can contain more than one NZP CSI-RS resource set for channel measurement. If the CSI resource setting for channel measurement contains multiple NZP CSI-RS resource sets for aperiodic CSI report, only one NZP CSI-RS resource set can be selected and indicated to a UE. For aperiodic CSI reporting, a list of trigger states is given by the higher layer parameters CSI-AperiodicTriggerStateList. Each trigger state in CSI-AperiodicTriggerStateList contains a list of associated CSI-ReportConfigs, each indicating a resource set ID for channel and optionally a resource set ID for interference. For a UE configured with the higher layer parameter CSI-AperiodicTriggerStateList, if a Resource Setting linked to a CSI-ReportConfig has multiple aperiodic NZP CSI-RS resource sets, only one of the aperiodic NZP CSI-RS resource sets from the Resource Setting is associated with the trigger state, and the UE is higher layer configured per trigger state per Resource Setting to select the one NZP CSI-RS resource set from the Resource Setting.

When more than one NZP CSI-RS resources are contained in the selected NZP CSI-RS resource set for channel measurement, a CRI is reported by the UE to indicate to the gNB the one selected NZP CSI-RS resource in the resource set, together with RI, PMI and CQI associated with the selected NZP CSI-RS resource. This type of CSI assumes that a PDSCH is transmitted from a single TRP, and the CSI is also referred to as single TRP CSI.

### Data Transmission Over Multiple TRPs or Panels

A PDSCH may be transmitted to a UE from multiple TRPs. Since different TRPs may be located in different physical locations and have different beams, the propagation channels can be different. To facilitate receiving PDSCH data from different TRPs or beams, a UE may be configured by Radio Resource Control (RRC) with multiple TCI states. A TCI state contains Quasi Co-location (QCL) information between the DMRS for PDSCH and one or two DL reference signals such as NZP CSI-RS or SSB.

Different NZP CSI-RSs or SSBs may be associated with different TRPs or beams. The QCL information can be used by a UE to apply large scale channel properties associated with the DL reference signals (NZP CSI-RS or SSB) to DMRS of PDSCH for channel estimation and PDSCH reception.

The supported QCL information types in NR are:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

A subset of the RRC configured TCI states may be activated by Medium Access Control (MAC) Control Element (CE) for PDSCH. In addition, the MAC CE also provides a mapping between TCI code points in DCI and the subset of TCI states. A TCI codepoint may be mapped to either one or two TCI states. Thus, one or two TCI states may be dynamically selected and indicated in the DCI scheduling a PDSCH depending on over which TRP(s) or beam(s) the PDSCH is to be transmitted. Each codepoint of the TCI field in DCI can indicate either 1 TCI state or two TCI states. A TCI field codepoint indicating 1 TCI state can be used to transmit PDSCH from a single TRP or single beam. If a TCI field codepoint indicates 2 TCI states, then PDSCH can be transmitted from two TRPs or two beams.

### Non-Coherent Joint Transmission (NC-JT)

NC-JT refers to Multiple Input Multiple Output (MIMO) data transmission over multiple TRPs in which different MIMO layers are sent over different TRPs. An example is shown in FIG. 5 where a PDSCH is sent to a UE over two TRPs, each carrying one code word. When the UE has four receive antennas while each of the TRPs has only two transmit antennas, the UE can support up to four MIMO layers but there are a maximum two MIMO layers from each TRP. In this case, by transmitting data over two TRPs to the UE, the peak data rate to the UE can be increased because up to four aggregated layers from the two TRPs can be used. This is beneficial when the traffic load, and thus the resource utilization, is low in each TRP. The scheme can also be beneficial in the case where the UE is in line of sight (LOS) of both the TRPs and the rank per TRP is limited even when there are more transmit antennas available at each TRP.

This type of NC-JT is supported in LTE with two TRPs, each having up to eight antenna ports. For CSI feedback purpose, a UE may be configured with a CSI process with two NZP CSI-RS resources, one for each TRP, and one interference measurement resource. The UE may report one of the following scenarios:
1. A UE reports CRI=0, which indicates that CSI is calculated and reported only for the first NZP CSI-RS resource, i.e., a RI, a PMI and a CQI associated with the first NZP CSI-RS resource is reported. This is the case when the UE sees best throughput is achieved by transmitting a PDSCH over the TRP or beam associated with the first NZP CSI-RS resource.
2. A UE reports CRI=1, which indicates that CSI is calculated and reported only for the second NZP CSI-RS resource, i.e., a RI, a PMI and a CQI associated with the second NZP CSI-RS resource is reported. This is the case when the UE sees best throughput is achieved by transmitting a PDSCH over the TRP or beam associated with the second NZP CSI-RS resource.
3. A UE reports CRI=2, which indicates both of the two NZP CSI-RS resources. In this case, two set of CSIs, one for each codeword, are calculated and reported based on the two NZP CSI-RS resources and by considering inter-codeword interference caused by the other codeword. The combinations of reported RIs are restricted such that |RI1-RI2|<=1, where RI1 and RI2 correspond to ranks associated with the 1^{st} and the 2^{nd} NZP CSI-RS, respectively.

In NR Release 16, a different approach is adopted where a single codeword is transmitted across two TRPs. An example of NC-JT supported in NR Release 16 is shown in FIG. 6, where one layer is transmitted from each of two TRPs in this example.

### SUMMARY

Systems and methods are disclosed herein for Channel State Information (CSI) feedback for Non-Coherent Joint Transmission (NC-JT). In one embodiment, a method performed by a wireless communication device for reporting CSI in a wireless network comprises receiving a CSI report configuration that comprises either: a first group of one or more Non-Zero Power CSI reference signal (NZP CSI-RS) resources for channel measurement and a second group of one or more NZP CSI-RS resources for channel measurement or a list of NZP CSI-RS resource tuples each comprising one or more NZP CSI-RS resources for channel measurement. The method further comprises selecting a first NZP CSI-RS resource and/or a second NZP CSI-RS resources in the first group of one or more NZP CSI-RS resources and/or the second group of one or more NZP CSI-RS resources, respectively, or in a NZP CSI-RS resource tuple in the list of NZP CSI-RS resource tuples. The method further comprises reporting, to a network node, information comprising CSI based on the first NZP CSI-RS resource and/or the second NZP CSI-RS resources.

In one embodiment, the first group of one or more NZP CSI-RS resources and the second group of one or more NZP CSI-RS resources are associated with a first transmission and reception point (TRP) and a second TRP, respectively.

In one embodiment, each of the list of NZP CSI-RS resource tuples comprises one NZP CSI-RS resource associated with a first TRP and another NZP CSI-RS resource associated with a second TRP.

In one embodiment, the reported information further comprises an indication of the selected first NZP CSI-RS resource and/or second NZP CSI-RS resources.

In one embodiment, selecting the first NZP CSI-RS resource and/or the second NZP CSI-RS resources comprises selecting the first NZP CSI-RS resource and the second NZP CSI-RS resource, and the CSI is CSI corresponding to NC-JT associated with the first NZP CSI-RS resource and the second NZP CSI-RS resource. In another embodiment, the CSI is CSI corresponding to NC-JT associated with the NZP CSI-RS tuple. In another embodiment, selecting the first NZP CSI-RS resource and/or the second NZP CSI-RS resources comprises selecting the first NZP CSI-RS resource or the second NZP CSI-RS resource, and the CSI is CSI corresponding to the selected first or second NZP CSI-RS resource. In another embodiment, the CSI is reference signal received power (RSRP) associated with each of the selected first and/or second NZP CSI-RS resources. In another embodiment, the CSI is signal to interference and noise ratio (SINR) associated with each of the selected first and/or the second NZP CSI-RS resources.

In one embodiment, the first group of one or more NZP CSI-RS resources and the second group of one or more NZP CSI-RS resources correspond to a first NZP CSI-RS resource set and a second NZP CSI-RS resource set, respectively. In one embodiment, the first NZP CSI-RS resource set and the second NZP CSI-RS resource set are configured in two CSI resource settings comprised in the CSI report configuration. In one embodiment, the wireless network is a New Radio, NR, network, the CSI report configuration is a CSI-ReportConfig that is extended to contain two resourcesForChannelMeasurment pointing to the first and second NZP CSI-RS resource sets, respectively. In one embodiment, the wireless network is a New Radio (NR) network, the CSI report configuration is a CSI-ReportConfig a first of the two CSI resource settings is a first resourcesForChannelMeasurment comprised within the CSI-ReportConfig that points to the first NZP CSI-RS resource set, and a second of the two CSI resource settings is a second resourcesForChannelMeasurment comprised within the CSI-ReportConfig that points to the second NZP CSI-RS resource set. In one embodiment, the wireless network is a NR network, the reporting is an aperiodically triggered CSI report, and the first and second NZP CSI-RS resource sets are indicated per CSI-AssociatedReportConfigInfo in a CSI-AperiodicTriggerStateList information element. In one embodiment, the first NZP CSI-RS resource set and the second NZP CSI-RS resource set are comprised in a single CSI resource setting included the CSI report configuration. In one embodiment, the first NZP CSI-RS resource set and the second NZP CSI-RS resource set comprised in the single CSI resource setting are configured in an aperiodic CSI trigger state associated with the CSI report configuration. In one embodiment, the aperiodic CSI trigger state further contains a first Quasi Co-location (QCL) indication and a second QCL indication for the first NZP CSI-RS resource set and the second NZP CSI-RS resource set, respectively.

In one embodiment, the first group of one or more NZP CSI-RS resources and the second group of one or more NZP CSI-RS resources are contained in a single NZP CSI-RS resource set. In one embodiment, each NZP CSI-RS resource in the first and second groups is associated with an index that indicates whether the NZP CSI-RS resource is in the first or the second group. In one embodiment, the first group of one or more NZP CSI-RS resources or the second group of one or more NZP CSI-RS resources is identified by an index included in each NZP CSI-RS resource configuration. In one embodiment, the index is one of: an index of a transmission configuration indicator (TCI), a Control Resource Pool Index, or a new group index.

In one embodiment, the list of NZP CSI-RS resource tuples is contained in a single NZP CSI-RS resource set.

In one embodiment, selecting the first NZP CSI-resource and/or the second NZP CSI-RS resource comprises selecting the first NZP CSI-resource and/or the second NZP CSI-RS resource based on a predetermined metric. In one embodiment, the metric is downlink throughput.

In one embodiment, the CSI based on the selected first and/or second NZP CSI-RS resource(s) comprises: (a) a rank indicator (RI) for each selected NZP CSI-RS resource, (b) a precoding matrix indicator (PMI) for each selected NZP CSI-RS resource, (c) a channel quality indicator (CQI) for each selected NZP CSI-RS resource, (d) a joint CQI for a pair of selected NZP CSI-RS resources, (e) a layer one reference signal received power (L1-RSRP) for each selected NZP CSI-RS resource, (f) a layer one signal to interference and noise ratio (L1-SINR) for each selected NZP CSI-RS resource, (g) a NZP CSI-RS resource indicator (CRI) for each selected NZP CSI-RS resource, (h) a NZP CSI-RS resource group indicator (CRGI) for each selected NZP CSI-RS resource, (i) a NZP CSI-RS tuple indicator for a selected NZP CSI-RS tuple, or (j) any combination of two or more of (a)-(i).

In one embodiment, selecting the first NZP CSI-RS resource and/or the second NZP CSI-RS resources comprises selecting the first NZP CSI-RS resource and the second NZP CSI-RS resource, and the CSI based on the selected first and second NZP CSI-RS resources comprises a first and a second NZP CSI-RS resource indicator (CRI1, CRI2), and associated respectively a first and a second rank indicator (RI1, RI2), a first and a second precoding matrix indicator (PMI1, PMI2), and a joint channel quality indicator, CQI.

In one embodiment, selecting the first NZP CSI-RS resource and/or the second NZP CSI-RS resources comprises selecting (1402) the first NZP CSI-RS resource and the second NZP CSI-RS resource, and the CSI based on the selected first and second NZP CSI-RS resources comprises a first and a second NZP CSI-RS resource indicator (CRI1, CRI2), and associated respectively a first and a second rank indicator (RI1, RI2), a first and a second precoding matrix indicator (PMI1, PMI2), and a first and a second channel quality indicator (CQI1, CQI2).

In one embodiment, the CSI is calculated assuming NC-JT of a physical downlink shared channel (PDSCH) over antenna ports of the first and the second NZP CSI-RS resources on a same time and frequency resource.

In one embodiment, selecting the first NZP CSI-RS resource and/or the second NZP CSI-RS resources comprises selecting the first NZP CSI-RS resource and the second NZP CSI-RS resource, and the CSI based on the selected first and second NZP CSI-RS resource(s) comprises a first and a second NZP CSI-RS resource indicator (CRI1, CRI2), and associated respectively a first and a second RSRP or SINR.

In one embodiment, CRI1, CRI2, and/or CRGI may be jointly encoded.

In one embodiment, a mapping between a CRI to one or more NZP CSI-RS resources in the first and the second groups of NZP CSI-RS resources, or in the list of NZP CSI-RS tuples, may be configured either explicitly or implicitly.

In one embodiment, the indication of the selected one or more NZP CSI-RS resources comprises a RI=0 for the second or the first NZP CSI-RS resource.

In one embodiment, the CSI report configuration further includes a code book configuration.

In one embodiment, the CSI report configuration further includes a report quantity indicator indicating CSI report for NC-JT. In one embodiment, the report quantity indicator may further indicate whether the CSI report includes a joint CQI or a pair of CQIs.

In one embodiment, the CSI report configuration further includes one or more CSI interference measurement (CSI-IM) resources.

Corresponding embodiments of a wireless communication device are also disclosed. In one embodiment, a wireless communication device for reporting CSI in a wireless network is adapted to receive a CSI report configuration that comprises either:

a first group of one or more NZP CSI-RS resources for channel measurement and a second group of one or more NZP CSI-RS resources for channel measurement or a list of NZP CSI-RS resource tuples each comprising one or more NZP CSI-RS resources for channel measurement. The wireless communication device is further adapted to select a first NZP CSI-RS resource and/or a second NZP CSI-RS resource in the first group of one or more NZP CSI-RS resources and/or the second group of one or more NZP CSI-RS resources, respectively, or in a NZP CSI-RS resource tuple in the list of NZP CSI-RS resource tuples. The wireless communication device is further adapted to report, to a network node, information comprising CSI based on the selected first and/or the second NZP CSI-RS resource(s).

In one embodiment, a wireless communication device for reporting CSI in a wireless network comprises one or more transmitters, one or more receivers, and processing circuitry associated with the one or more transmitters and the one or more receivers. The processing circuitry is configured to cause the wireless communication device to receive a CSI report configuration that comprises either: a first group of one or more NZP CSI-RS resources for channel measurement and a second group of one or more NZP CSI-RS resources for channel measurement or a list of NZP CSI-RS resource tuples each comprising one or more NZP CSI-RS resources for channel measurement. The processing circuitry is further configured to cause the wireless communication device to select a first NZP CSI-RS resource and/or a second NZP CSI-RS resource in the first group of one or more NZP CSI-RS resources and/or the second group of one or more NZP CSI-RS resources, respectively, or in a NZP CSI-RS resource tuple in the list of NZP CSI-RS resource tuples. The processing circuitry is further configured to cause the wireless communication device to report, to a network node, information comprising CSI based on the selected first and/or the second NZP CSI-RS resource(s).

Embodiments of a method performed by a network node are also disclosed. In one embodiment, a method performed by a network node comprises providing, to a wireless communication device, a CSI report configuration that comprises either: a first group of one or more NZP CSI-RS resources for channel measurement and a second group of one or more NZP CSI-RS resources for channel measurement or a list of NZP CSI-RS resource tuples each comprises one or more NZP CSI-RS resources for channel measurement. The method further comprises receiving, from the wireless communication device, information comprising CSI based on a selected one or more NZP CSI-RS resources.

In one embodiment, the first group of one or more NZP CSI-RS resources and the second group of one or more NZP CSI-RS resources are associated with a first TRP and a second TRP, respectively.

In one embodiment, each of the list of NZP CSI-RS resource tuples comprises one NZP CSI-RS resource associated with a first TRP and another NZP CSI-RS resource associated with a second TRP.

In one embodiment, the reported information further comprises an indication of the selected first and/or second NZP CSI-RS resource(s).

In one embodiment, the selected one or more NZP CSI-RS resources comprise a first NZP CSI-RS resource and a second NZP CSI-RS resource from the first group of one or more NZP CSI-RS resources and the second group of one or more NZP CSI-RS resources, respectively, or from a NZP CSI-RS resource tuple from the list of CSI-RS resource tuples, and the CSI is CSI corresponding to NC-JT associated with the first and the second NZP CSI-RS resources. In another embodiment, the selected one or more NZP CSI-RS resources comprise a first NZP CSI-RS resource and a second NZP CSI-RS resource selected from a NZP CSI-RS resource tuple from the list of NZP CSI-RS resource tuples, and the CSI is CSI corresponding to NC-JT associated with the NZP CSI-RS tuple. In another embodiment, the selected one or more NZP CSI-RS resources comprise a first NZP CSI-RS resource or a second NZP CSI-RS resource from the first group of one or more NZP CSI-RS resources or the second group of one or more NZP CSI-RS resources, respectively, or from a NZP CSI-RS resource tuple from the list of CSI-RS resource tuples, and the CSI is CSI corresponding to the selected first or second NZP CSI-RS resource. In another embodiment, the CSI is RSRP associated with each of the selected one or more NZP CSI-RS resources. In another embodiment, the CSI is SINR associated with each of the selected one or more NZP CSI-RS resources.

In one embodiment, the first group of one or more NZP CSI-RS resources and the second group of one or more NZP CSI-RS resources are contained in a single NZP CSI-RS resource set. In one embodiment, each NZP CSI-RS resource in the first and second groups is associated with an index that indicates whether the NZP CSI-RS resource is in the first or second group. In one embodiment, the first group of one or more NZP CSI-RS resources or the second group of one or more NZP CSI-RS resources are identified by an index included in each NZP CSI-RS resource configuration. In one embodiment, the index may be one of: an index of a TCI, a Control Resource Pool Index, or a new group index.

In one embodiment, the list of NZP CSI-RS resource tuples is contained in a single NZP CSI-RS resource set.

In one embodiment, the CSI based on the selected one or more NZP CSI-RS resources comprises: (a) a RI for each selected NZP CSI-RS resource, (b) a PMI for each selected NZP CSI-RS resource, (c) a CQI for each selected NZP CSI-RS resource, (d) a joint CQI for a pair of selected NZP CSI-RS resources, (e) a L1-RSRP for each selected NZP CSI-RS resource, (f) a L1-SINR for each selected NZP CSI-RS resource, (g) a CRI for each selected NZP CSI-RS resource, (h) a CRGI for each selected NZP CSI-RS resource, (i) a NZP CSI-RS tuple indicator for each selected tuples of NZP CSI-RS resources, (j) any combination of two or more of (a)-(i).

In one embodiment, the selected one or more NZP CSI-RS resources comprise a first NZP CSI-RS resource and a second NZP CSI-RS resource from the first group of one or more NZP CSI-RS resources and the second group of one or more NZP CSI-RS resources, respectively, or from a NZP CSI-RS resource tuple from the list of CSI-RS resource tuples, and the CSI based on the selected first and second NZP CSI-RS resources comprises a first and a second NZP CSI-RS resource indicator (CRI1, CRI2), and associated respectively a first and a second rank indicator, (RI1, RI2), a first and a second precoding matrix indicator (PMI1, PMI2), and a joint channel quality indicator, CQI.

In one embodiment, the selected one or more NZP CSI-RS resources comprise a first NZP CSI-RS resource and a second NZP CSI-RS resource from the first group of one or more NZP CSI-RS resources and the second group of one or more NZP CSI-RS resources, respectively, or from a NZP CSI-RS resource tuple from the list of CSI-RS resource tuples, and the CSI based on the selected first and second NZP CSI-RS resources comprises a first and a second NZP CSI-RS resource indicator (CRI1, CRI2), and associated respectively a first and a second rank indicator, (RI1, RI2), a first and a second precoding matrix indicator (PMI1, PMI2), and a first and a second channel quality indicator (CQI1, CQI2).

In one embodiment, the selected one or more NZP CSI-RS resources comprise a first NZP CSI-RS resource and a second NZP CSI-RS resource from the first group of one or more NZP CSI-RS resources and the second group of one or more NZP CSI-RS resources, respectively, or from a NZP CSI-RS resource tuple from the list of CSI-RS resource tuples, and the CSI is calculated assuming non-coherent joint transmission, NC-JT, of a physical downlink shared channel, PDSCH, over antenna ports of the first and the second NZP CSI-RS resources on a same time and frequency resource.

In one embodiment, the selected one or more NZP CSI-RS resources comprise a first NZP CSI-RS resource and a second NZP CSI-RS resource from the first group of one or more NZP CSI-RS resources and the second group of one or more NZP CSI-RS resources, respectively, or from a NZP CSI-RS resource tuple from the list of CSI-RS resource tuples, and the CSI based on the selected first and second NZP CSI-RS resources comprises a first and a second NZP CSI-RS resource indicator (CRI1, CRI2), and associated respectively a first and a second RSRP or SINR.

In one embodiment, CRI1, CRI2, and/or CRGI may be jointly encoded.

In one embodiment, the indication of the selected one or more NZP CSI-RS resources comprises a RI=0 for the second or the first NZP CSI-RS resource.

In one embodiment, the CSI report configuration further includes a code book configuration.

In one embodiment, the CSI report configuration further includes a report quantity indicator indicating CSI report for NC-JT. In one embodiment, the report quantity indicator may further indicate whether the CSI report includes a joint CQI or a pair of CQIs.

In one embodiment, the CSI report configuration further includes one or more CSI-IM resources.

Corresponding embodiments of a network node are also disclosed. In one embodiment, a network node is adapted to provide, to a wireless communication device, a CSI report configuration that comprises either: a first group of one or more NZP CSI-RS resources for channel measurement and a second group of one or more NZP CSI-RS resources for channel measurement or a list of NZP CSI-RS resource tuples each comprises one or more NZP CSI-RS resources for channel measurement. The network node is further adapted to receive, from the wireless communication device, information comprising CSI based on a selected one or more NZP CSI-RS resources.

In one embodiment, a network node comprises processing circuitry configured to cause the network node to provide, to a wireless communication device, a CSI report configuration that comprises either: a first group of one or more NZP CSI-RS resources for channel measurement and a second group of one or more NZP CSI-RS resources for channel measurement or a list of NZP CSI-RS resource tuples each comprises one or more NZP CSI-RS resources for channel measurement. The processing circuitry is further configured to cause the network node to receive, from the wireless communication device, information comprising CSI based on a selected one or more NZP CSI-RS resources.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of the New Radio (NR) time-domain structure;

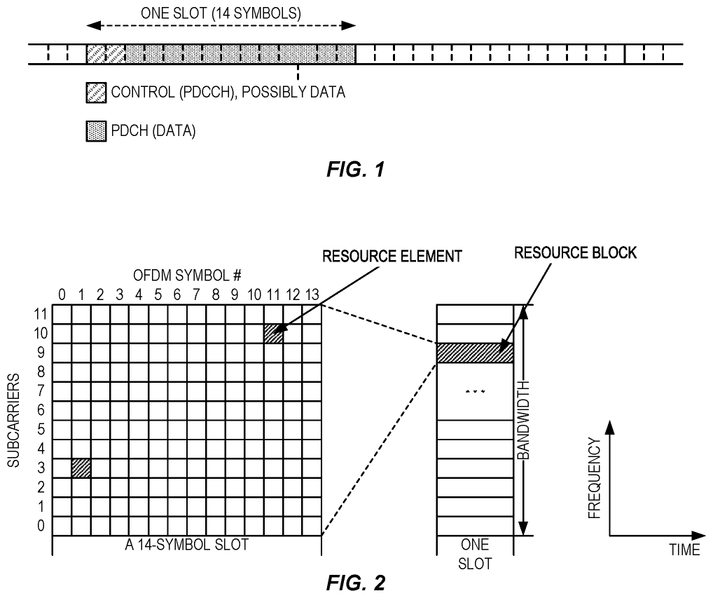

FIG. 2 illustrates the basic NR time-frequency resource grid;

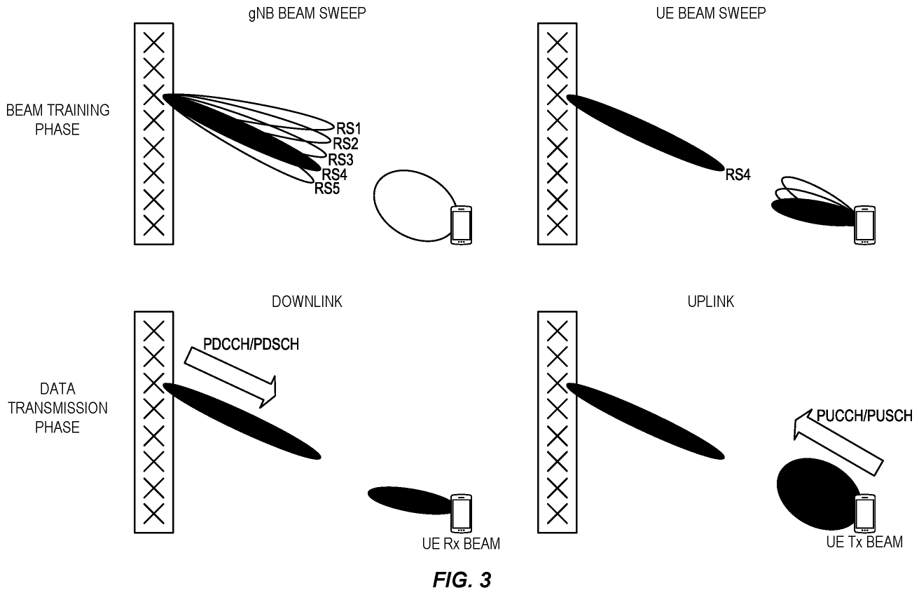

FIG. 3 illustrates NR downlink beam management;

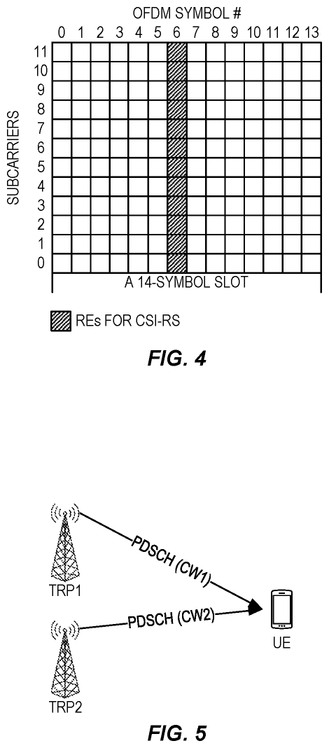

FIG. 4 shows an example of Channel State Information (CSI) Reference Signal (CSI-RS) resource elements (REs) for twelve (12) antenna ports, where one RE per RB per port is shown;

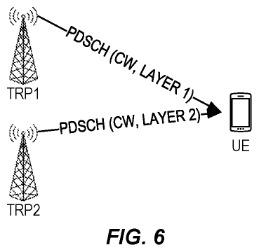

FIG. 5 illustrates an example of Non-Coherent Joint Transmission (NC-JT) where a Physical Downlink Shared Channel (PDSCH) is sent to a User Equipment (UE) over two Transmission/Reception Points (TRPs), each carrying one codeword;

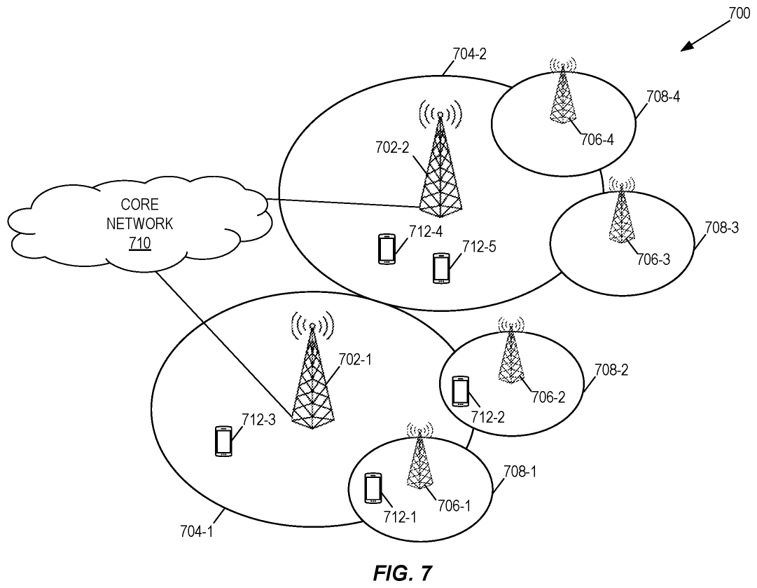

FIG. 6 illustrates an example of NC-JT supported in NR Release 16, where one layer is transmitted from each of two TRPs;

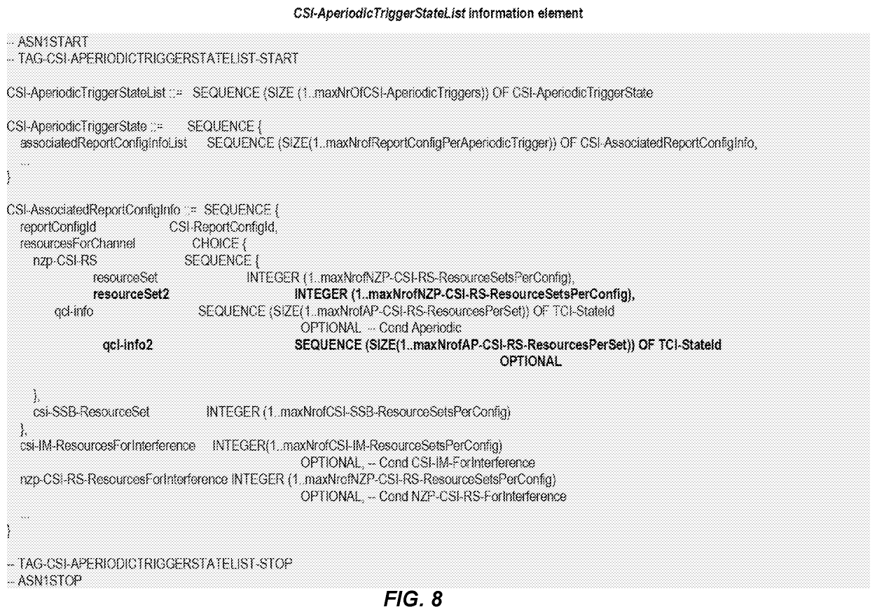

FIG. 7 illustrates one example of a cellular communications system in which embodiments of the present disclosure may be implemented;

FIG. 8 illustrates an example in accordance with an embodiment of the present disclosure;

FIG. 9 illustrates an example of CSI feedback based on two groups of NZP CSI-RS resources for channel measurement in accordance with an embodiment of the present disclosure;

FIG. 10 illustrates an example of two-part CSI encoding in accordance with an embodiment of the present disclosure;

FIG. 11 illustrates an example of UE receive (Rx) beam sweep in identifying the best Rx beam for receiving signals from each TRP in accordance with an embodiment of the present disclosure;

FIG. 12 illustrate examples of two-part CSI encoding in accordance with an embodiment of the present disclosure;

FIG. 13 illustrates an example of an option to extend the individual NZP CSI-RS resource set configured in a CSI-ResourceConfig in accordance with an embodiment of the present disclosure;

FIG. 14 illustrates the operation of a wireless communication device (e.g., a UE) and network node (e.g., a radio access node such as, e.g., a base station (e.g., gNB)) in accordance with at least some of the embodiments of the present disclosure;

FIG. 14B illustrates the operation of a wireless communication device (e.g., a UE) and network node (e.g., a radio access node such as, e.g., a base station (e.g., gNB)) in accordance with some other embodiments of the present disclosure;

FIGS. 15 through 17 are schematic block diagrams of a radio access node in accordance with some example embodiments of the present disclosure;

FIGS. 18 and 19 are schematic block diagrams of a wireless communication device or UE in accordance with some example embodiments of the present disclosure;

FIG. 20 illustrates an example embodiment of a communication system in which embodiments of the present disclosure may be implemented;

FIG. 21 illustrates example embodiments of the host computer, base station, and UE of FIG. 20; and

FIGS. 22 through 25 are flow charts that illustrate example embodiments of methods implemented in a communication system such as that of FIG. 20.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the radio access network or the core network of a cellular communications network/system.

Transmit/Receive Point (TRP): As used herein, a TRP is part of the base station (e.g., gNB) transmitting and receiving radio signals to/from the wireless communication device (e.g., UE) according to physical layer properties and parameters inherent to that element.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). LTE-like CSI feedback for Non-Coherent Joint Transmission (NC-JT) has the following limitations:
It assumes one codeword is transmitted from each TRP, while in NR a codeword can be transmitted from two TRPs.
It is applicable to low carrier frequency range (FR1) in which a single NZP CSI-RS resource is typically associated with one TRP. On the other hand, in NR at high carrier frequency (FR2), multiple beams may be formed from each TRP and thus multiple NZP CSI-RS resources may be configured for each TRP. To use CSI feedback similar to LTE, the gNB needs to first determine one beam from each TRP and then request a CSI feedback with two NZP CSI-RS resources for channel measurement. Thus, an extra step is needed, which leads to the following problems:
   Use of LTE-like NC-JT CSI feedback in NR would mean there is more delay in acquiring CSI feedback for NC-JT in NR.
   The additional step needed to first determine one beam from each TRP would mean additional overhead in both downlink (i.e., downlink control overhead involved with the extra step) and uplink (i.e., uplink control overhead involved with the extra step).

Certain aspects of the present disclosure and their embodiments may provide solutions to the aforementioned or other challenges. In one aspect, a method is proposed such that a UE can be configured to report CSI, where the channel measurement is based on more than one NZP CSI-RS resource. The configuration may be based on two groups of NZP CSI-RS resources, each group containing more than one NZP CSI-RS resource for channel measurement, and each group may be associated with one TRP. Note that it is also possible that each group is associated with different panels of one TRP. In one embodiment, the UE selects either one NZP CSI-RS resource or two NZP CSI-RS resources, one from each group, based on the maximum achievable UE throughput, and reports CSI accordingly. When one NZP CSI-RS resource is selected, a CSI associated with the resource is reported together with a CRI indicating the selected resource. If two resources are selected, a CRI, a pair of RIs, and a pair of PMIs together with a joint CQI conditioned on the pair of RIs and the pair of PMIs are reported. The CRI reported indicates the selected two NZP CSI-RS resources. One bit is used to indicate whether one resource or two resources is selected. Note that the CRI in the report is optional and might not be needed if the method is used for a UE receiving (RX) beam sweep. The UE may also be explicitly configured with a number of NZP-CSI-RS resource sets, in which case the UE estimates the CSI resulting from simultaneous reception of all the NZP CSI-RS resources in each set. The UE would report the CRI corresponding to the NZP-CSI-RS resource set number, and one PMI, RI per NZP CSI-RS resource in the reported set, along with a joint CQI.

There are, proposed herein, various embodiments which address one or more of the issues disclosed herein. Some example embodiments of the present disclosure are as follows.

Embodiment 1: A method performed by a wireless device for reporting CSI in a wireless network, the method comprising:
receiving a CSI report configuration that contains a first and a second group of one or more NZP CSI-RS resources for channel measurement; and
determining one of following options
   i. a first NZP CSI-RS resource in the first group;
   ii. a second NZP CSI-RS resource in the second group;
   iii. a first NZP CSI-RS resource in the first group and a second NZP CSI-RS resource in the second group; and
reporting CSI based on the determined one of the first NZP CSI-RS resource, the second NZP CSI-RS resource, and both the first and the second NZP CSI-RS resources, and an indication of the determined first and/or second NZP CSI-RS resource.

Embodiment 2: The method of embodiment 1, wherein the first and the second group of NZP CSI-RS resources correspond to a first and a second NZP CSI-RS resource set, respectively.

Embodiment 3: The method of embodiments 1 and 2, wherein the first and the second NZP CSI-RS resource sets are configured in two CSI resource settings included in the CSI report configuration.

Embodiment 4: The method of embodiments 1 and 2, wherein the first and the second NZP CSI-RS resource sets are included in a single CSI resource setting included the CSI report configuration.

Embodiment 5: The method of embodiments 1, 2, and 4, wherein the first and the second NZP CSI-RS resource sets in the CSI resource setting are configured in an aperiodic CSI trigger state associated with the CSI report configuration.

Embodiment 6: The method of embodiment 5, wherein the aperiodic CSI trigger state further contains a first and a second Quasi Co-location (QCL) indications for the first and the second NZP CSI-RS resource sets, respectively.

Embodiment 7: The method of embodiment 1, wherein the first and the second group of NZP CSI-RS resources are contained in a single NZP CSI-RS resource set.

Embodiment 8: The method of embodiment 7, wherein the first or the second group of NZP CSI-RS resources are identified by an index included in each NZP CSI-RS resource configuration.

Embodiment 9: The method of embodiment 8, wherein the index may be one of:
an index of a transmission configuration indicator (TCI), or
a Control Resource Pool Index, or
a new group index.

Embodiment 10: The method of embodiment 1, wherein the determining may be based on the maximum downlink throughput that can be provided with each option.

Embodiment 11: The method of embodiment 1, wherein the CSI based on the determined the first or the second NZP CSI-RS resource includes one or more of a rank indicator (RI), a precoding matrix indicator (PMI), a channel quality indicator (CQI), a layer one received reference signal power (L1-RSRP) or signal to interference and noise ratio (L1-SINR), a NZP CSI-RS resource indicator (CRI), and a NZP CSI-RS resource group indicator (CRGI).

Embodiment 12: The method of embodiment 1, wherein the CSI based on the determined the first and the second NZP CSI-RS resources includes a first and a second NZP CSI-RS resource indicator (CRI1, CR2) and associated respectively a first and a second rank indicator (RI1, RI2), a first and a second precoding matrix indicator (PMI1, PMI2), and a joint channel quality indicator, CQI.

Embodiment 13: The method of embodiment 1, wherein the CSI based on the determined the first and the second NZP CSI-RS resources includes a first and a second NZP CSI-RS resource indicator (CRI1, CRI2) and associated respectively a first and a second rank indicator (RI1, RI2), a first and a second precoding matrix indicator (PMI1, PMI2), and a first and a second channel quality indicator (CQI1, CQI2).

Embodiment 14: The method of embodiments 12 to 13, wherein the CSI is calculated assuming non-coherent joint transmission (NC-JT) of a Physical Downlink Shared Channel (PDSCH) over antenna ports configured in both the first and the second NZP CSI-RS resources on a same time and frequency resource.

Embodiment 15: The method of embodiment 1, wherein the CSI based on the determined the first and the second NZP CSI-RS resources includes a first and a second NZP CSI-RS resource indicator (CRI1, CRI2), and associated respectively a first and a second RSRP or SINR.

Embodiment 16: The method of embodiments 11 to 15, wherein CRI1, CRI2, and/or CRGI may be jointly encoded.

Embodiment 17: The method of embodiments 11 to 15, wherein the determined first (or second) NZP CSI-RS resource may be indicated with a RI=0 for the second (or the first) NZP CSI-RS resource.

Embodiment 18: The method of embodiment 1, wherein the CSI report configuration further includes a code book configuration.

Embodiment 19: The method of embodiment 1, wherein the CSI report configuration further includes report quantity indicator indicating CSI report for NC-JT.

Embodiment 20: The method of embodiments 1 to 18, wherein the report quantity indicator may further indicate whether the CSI report includes a joint CQI or a pair of CQIs.

Embodiment 21: The method of embodiments 1 to 18, wherein the CSI report configuration further includes one or more CSI interference measurement (CSI-IM) resources.

Embodiment 22: A method performed by a wireless device for reporting CSI in a wireless network, the method comprising:
receiving a configuration of a NZP CSI-RS resource set containing a list of NZP CSI-RS resource tuples each including one or more NZP CSI-RS resources; and
receiving a CSI report configuration including the NZP CSI-RS resource set for channel measurement; and
determining an NZP CSI-RS resource tuple out of the list of NZP CSI-RS resource tuples; and
reporting CSI based on the determined NZP CSI-RS resource tuple, and an indication of the determined NZP CSI-RS resource tuple.

Embodiment 23: The method of embodiment 22, wherein the CSI includes an NZP CSI-RS resource tuple indicator, CRTI, and one or more of a RI and a PMI, a L1-RSRP, or L1-SINR for each NZP CSI-RS resource in the tuple, and a joint CQI.

Certain embodiments may provide one or more of the following technical advantage(s). Embodiments disclosed herein let a UE select one or two TRP beams from multiple candidate beams and report the selected beams and CSI. This reduces the steps in determining the best beams from multiple TRPs (or multiple panels from the same TRP), each with multiple beams. By grouping NZP CSI-RS resources for channel measurement according to the associated TRP, it makes sure only one beam is selected from each NZP CSI-RS resource group. It also reduces the number of beam combinations that a UE need to search and as well as feedback overhead for CRIs.

In case an embodiment of the solution is used for a UE RX beam sweep instead of TRP TX beam sweep, the method will allow the UE to determine suitable UE TX beams for multi TRP/multi-panel transmission based on user throughput performance, which will improve the user throughput performance. The method will also let the UE report back CSI in direct relation to a UE RX beam sweep, which removes the need for one additional CSI-RS transmission that would otherwise be required to determine suitable CSI.

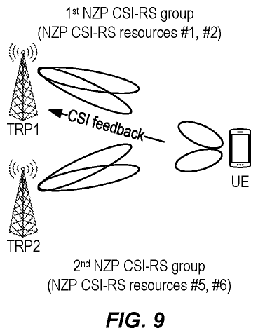

FIG. 7 illustrates one example of a cellular communications system 700 in which embodiments of the present disclosure may be implemented. In the embodiments described herein, the cellular communications system 700 is a 5G system (5GS) including a NR RAN. In this example, the RAN includes base stations 702-1 and 702-2, which in 5G NR are referred to as gNBs, controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or Remote Radio Heads (RRHs), or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5GS is referred to as the 5G core (5GC). The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes UEs and, as such, sometimes referred to herein as UEs 712, but the present disclosure is not limited thereto.

Now, a description of some example embodiments is provided.

### NC-JT CSI Feedback with Two NZP CSI-RS Resource Groups

In this embodiment, a UE may be requested to report CSI for NC-JT based on two or more groups of NZP CSI-RS (or SSB) resources, for example a first and a second group, for channel measurement.

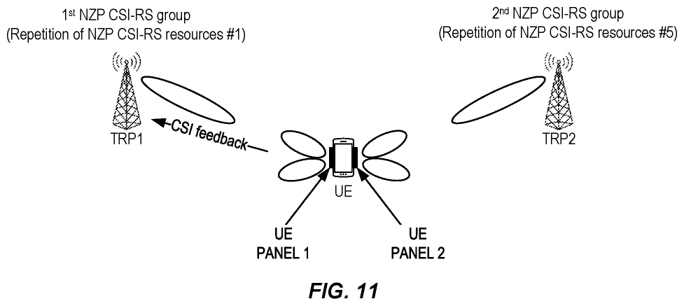

Each group of NZP CSI-RS (or SSB) for channel measurements may be associated with a TRP (or to different panels for the same TRP) and may contain one or more NZP CSI-RS (or SSB) resources, each may be associated with a beam. In one embodiment, the two or more different groups of NZP CSI-RS (or SSB) resources are associated with two or more different TCI states. An example is shown in FIG. 9, where two NZP CSI-RS groups each with two NZP CSI-RS resources are signaled to the UE 212 from two TRPs 900-1 and 900-1 (TRP1 and TRP2).

One scheme to group NZP CSI-RS is to use a NZP CSI-RS resource set as a group. The CSI-ReportConfig is thus extended to contain two or more resourcesForChannelMeasurement, each pointing to a group of NZP CSI-RS or SSB to be used for channel measurements.

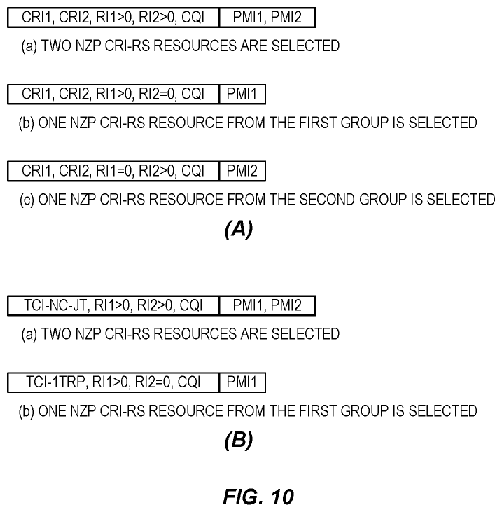

In another embodiment, for aperiodically triggered NC-JT CSI report, two or more NZP CSI-RS resource sets are introduced per CSI-AssociatedReportConfigInfo in CSI-AperiodicTriggerStateList information element where each NZP CSI-RS resource set is used as a group. As shown in the example of FIG. 8, resourceSet and resourceSet2 represent the two NZP CSI-RS resource sets that are introduced. Note that resourceSet2 field is optional as the 2^{nd} NZP CSI-RS resource set is only needed for aperiodic NC-JT CSI reporting and not needed for other (i.e., other than NC-JT) aperiodic CSI reporting.

Another aspect that is introduced in this embodiment is the introduction of two or more qcl-info fields per CSI-AssociatedReportConfigInfo. Each qcl-info field provides the TCI-States that in turn provide the QCL source and QCL type for each NZP-CSI-RS-Resource listed in an NZP CSI-RS resource set. In the example of FIG. 8, qcl-info provides the TCI-States corresponding to NZP CSI-RS resources in resourceSet, while qcl-info2 provides the TCI-States corresponding to NZP CSI-RS resources in resourceSet2. Note that qcl-info2 field is optional and is only present if the 2^{nd} NZP CSI-RS resource set (i.e., resourceSet2) is present in CSI-AssociatedReportConfigInfo.

It should be noted that NR Rel15/16 only allows one NZP CSI-RS resource set (i.e., resourceSet) and one QCL-Info (i.e., qcl-info) to be included per CSI-AssociatedReportConfigInfo, which is unsuitable for aperiodic NC-JT CSI reporting. Hence, with the proposed introduction of resourceSet2 and qcl-info2, the NR CSI framework can support aperiodic NC-JT reporting.

In another embodiment, the CSI-ResourceConfig IE is extended to allow more than one periodic and semi-persistent NZP CSI-RS resource sets for CSI measurements. In addition, more than one NZP CSI-RS (or SSB) resource set in a CSI Resource setting (higher layer parameter CSI-ResourceConfig) may be allowed to be configured in an aperiodic CSI trigger state. In this case, each NZP CSI-RS (or SSB) resource set corresponds to an NZP CSI-RS (or SSB) group.

Alternatively, the different groups of NZP CSI-RS resources can belong to the same NZP CSI-RS resource set. In case all NZP CSI-RS resources belong to the same NZP CSI-RS resource set, some other indication is needed to divide the NZP CSI-RS resources into different groups. In one such example, the NZP CSI-RS resources are divided into different groups based on their TCI states, such that NZP CSI-RS resources configured with the same TCI state belong to the same group. In another example, the NZP CSI-RS resources may be divided into different groups based on the QCL reference signal specified in their TCI states. For instance, NZP CSI-RS resources having a same SSB index or an NZP CSI-RS index in their TCI states belong to a same group.

In one embodiment, when the different groups of NZP CSI-RS resources belong to the same NZP CSI-RS resource set and a linked parameter like TCI state is used to distinguish in which group a NZP CSI-RS resource belongs to, UE would need to do this grouping after receiving the corresponding RRC configuration like TCI state and use this grouping when selecting CRI and corresponding CSI according to embodiments in this disclosure.

In another alternative, each NZP CSI-RS resource or group of NZP CSI-RS resources is associated with an index that indicates that these resources are transmitted from the same TRP. Such index can be called a “trp-index”. In aperiodic CSI reporting, the grouping information may be included in the DCI message that triggers the CSI report. For example, a CSI trigger state may contain multiple NZP CSI-RS resources and, by implicit or explicit indication, the belonging to a certain TRP is indicated.

Alternatively, the NZP-CSI resource set or each individual NZP-CSI resource may be extended to include a higher layer CORESETPoolIndex, and for example, the first group includes NZP CSI-RS resources with CORESETPoolIndex=0 and the second group includes NZP CSI-RS resources with CORESETPoolIndex=1.

FIG. 9 illustrates an example of CSI feedback based on two groups of NZP CSI-RS resources for channel measurement.

The UE selects one NZP CSI-RS resource in each group for CSI calculation. The determination may be based on the maximum DL UE throughput that could be achieved (for example using codebooks standardized in NR rel-15) when simultaneously receiving the two or more NZP CSI-RS resources. The UE may be equipped with one or more receive panels. The UE may report a CSI for one of the following two scenarios:
1. Only one NZP CSI-RS group is selected from the set of multiple groups, and one NZP CSI-RS resource is selected from the selected group,
2. Two NZP CSI-RS groups are selected and one resource from each of the two groups is selected.

In case of scenario 1, the reported CSI corresponds to single TRP CSI report in which the CSI calculation is based on the single selected NZP CSI-RS resource for channel measurement and contains a single set of RI, PMI, and CQI. A CRI is also reported to indicate the selected NZP CSI-RS resource in the selected group. A group indication may also be indicated in case the CRI only points out one of NZP CSI-RS resource in the selected group. Alternatively, the group selection is also implicitly indicated in the CRI, i.e. the CRI can select and indicate an NZP CSI-RS resource from more than one group, in which case the group indicator is not needed.

In case of scenario 2, the reported CSI corresponds to NC-JT CSI with a PDSCH being transmitted over two TRPs in which the CSI calculation is based on the two selected NZP CSI-RS resources for channel measurement and contains two sets of RIs and PMIs, one per NZP CSI-RS resource and a joint CQI conditioned on the two sets of RIs and PMIs by taking into account any cross layer or cross TRP interferences. A pair of CRIs are also reported to indicate the two selected NZP CSI-RS resources where each CRI can select a resource in a corresponding group. Alternatively, a group indicator (or pair of group indicators) is reported to select the two groups and in addition a CRI per group (selecting the resource within each selected group) is reported. If only two groups are configured, then the group indicator is not necessary and may not be reported.

In another embodiment, an alternative for scenario 2 above is scenario 3 in which, the report corresponds to NC-JT CSI with two PDSCHs scheduled by two PDCCHs and transmitted from two TRPs. In this case, instead of reporting a joint CQI, two different CQIs, one for each group/TRP may be reported. Whether CSI for single-PDSCH (scenario 2) or multi-PDSCH (scenario 3) should be reported could be indicated by adding a switch in the CSI-ReportConfig or be deduced by other higher-layer parameters.

Irrespective of scenario 1 or scenario 2, if the primary target with the CSI report is to have the UE recommend transmission from a subset of TRPs along with corresponding transmit beams (NZP CSI-RS resources), in one embodiment, the CSI-ReportConfig could be set up with a Report Quantity other than ‘cri-RI-PMI-CQI’ (as assumed above), such as ‘cri-RSRP’ or ‘cri-SINR’ in which a Layer 1 (L1) RSRP or L1-SINR is reported per selected NZP CSI-RS resource or beam In such a case, the current CSI report could be the first step in a CSI reporting procedure allowing subsequent UE RX-beam determination prior to reporting, e.g., RI, PMI and/or CQI.

In one embodiment, CSI report for NC-JT with two or more groups of NZP CSI-RS (or SSB) resources may be explicitly indicated. For example, the CSI report config IE which is signaled from gNB to the UE using RRC configuration contains a parameter “NC-JT” which is set to “enabled”. This parameter can be present in ReportQuantity IE.

In some other embodiments, whether a CSI report configuration corresponds to NC-JT CSI feedback or not is given implicitly by the number of CSI-RS resource sets (each corresponding to an NZP CSI-RS resource group) triggered or configured as follows:
In the case of periodic or semi-persistent CSI-RS resources, if the number of NZP CSI-RS resource sets configured per CSI-ResourceConfig is more than 1 and more than one NZP CSI-RS resource sets are selected in a CSI-AssociatedReportConfigInfo of a CSI-AperiodicTriggerState, then the corresponding CSI-ReportConfig associated with this CSI-ResourceConfig is to be used for NC-JT based CSI feedback. For instance, if a CSI-ReportConfig is associated with a CSI-ResourceConfig with more than 1 (e.g., 2) NZP CSI-RS resource sets, and more than one NZP CSI-RS resource sets are selected in CSI-ResourceConfig in a CSI-AperiodicTriggerState, then this CSI-ReportConfig has a report quantity (reportQuantity) set to multiple CRIs, multiple RIs, multiple PMIs and a CQI (e.g., 2 CRIs, 2 RIs, 2 PMIs, and a CQI). On the other hand, if the number of NZP CSI-RS resource sets configured per CSI-ResourceConfig is limited to one, then the CSI-ReportConfig associated with this CSI-ResourceConfig is to be used for non-NC-JT based CSI feedback as specified in NR Rel-15 and Rel-16.

In the case of aperiodic CSI-RS resources, if the number of NZP CSI-RS resource sets configured per CSI-AssociatedReportConfigInfo is more than 1 (e.g., 2), then this associated CSI-ReportConfig, when triggered aperiodically, is to be used for NC-JT based CSI feedback. For instance, if the number of NZP CSI-RS resource sets configured per CSI-AssociatedReportConfigInfo is more than 1 (e.g., 2), then this associated CSI-ReportConfig should have a report quantity (reportQuantity) set to multiple CRIs, multiple RIs, multiple PMIs, and a CQI (e.g., 2 CRIs, 2 RIs, 2 PMIs, and a CQI). On the other hand, if the number of NZP CSI-RS resource sets configured per CSI-AssociatedReportConfigInfo is limited to one, then this associated CSI-ResourceConfig is to be used for non-NC-JT based CSI feedback.

The CSI feedback bit size for scenario 1 is smaller than that for scenario 2 Thus, to reduce feedback overhead, different CSI sizes may be used for the two scenarios. In one embodiment, an additional 1-bit indicator may be first reported to indicate whether the CSI is for scenarios 1 or for scenario 2 so that the gNB knows either one or two sets of RI and PMI are reported. In this case, in one embodiment, a CSI report may consist of three parts. The first part contains the scenario indicator, the second part contains CRI, RI and wideband CQI, and the third part contains PMI(s). The first part is decoded to determine whether one or two RIs and PMIs in the second and third part. The second part is then decoded to determine the size of the third part.

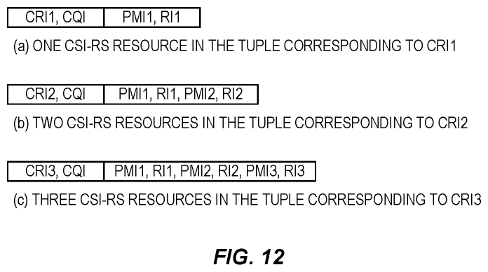

In another embodiment, two CRIs and two RIs may always be reported. In this case, a CSI report may consist of two parts and each part is encoded separately. The first part contains 2 CRIs, 2 RIs and CQI, and the second part contains PMI(s). The first part has a fixed size and is decoded to determine the size of the second part. Scenario 1 is indicated when one of the two RIs has a value of zero and in this case, the corresponding CRI is ignored. If one resource is selected, a single PMI would be reported in the second part. The size of the second part is further determined by the non-zero RI. An example is of two parts CSI encoding is illustrated in FIG. 10.

Alternatively, a TCI state is included in the report. An example of such two parts CSI encoding is illustrated in FIG. 10.

In a further embodiment, relevant for FR2, one more of the following restrictions listed in bullets below applies. Here, it is assumed that the network can configure the maximum rank per group. For example, from TRP1, the rank is at most 2 but, from TRP2, the transmission rank can be 4 since the gNB used for TRP2 is more advanced and capable of 4-layer transmission. Hence, a rank restriction per group is indicated from the network to the UE and this is taken into account when selecting the CSI for reporting. For example, in this example, a UE that can receive 4 layers, has to compare receiving all 4 layers from TRP2 or 2 layers from TRP1 and TRP respectively.

The UE finds the choice that maximizes the spectral efficiency or throughput, given a certain BLER target.
The UE shall not select more than one NZP CSI-RS per group,
The UE shall not report RI above the maximum RI for the group,
If the UE selects more than one NZP CSI-RS resource, then it shall be able to receive them simultaneously,
Only certain combination of RIs may be reported if more than one group is selected.
   With these rules, it is ensured that the UE is reporting a recommended transmission hypothesis and CSI for a combination of TRPs or a selection of a TRP that the network is able to deliver and the UE can receive.

In another embodiment, the TRP beam has already been determined for each TRP, and the TRP will now allow the UE to determine suitable UE RX beams for respective UE panel (where in this case each UE panel is associated to one TRP). The gNB will then set up a UE receive (RX) beam sweep with two groups of NZP CSI-RS resources (each group corresponding to one TRP beam for one TRP and thus contains one NZP CSI-RS resource), and where the NZP CSI-RS resource set(s) used for the UE RX beam sweep has ‘repetition’ parameter set to ‘on’. The UE can then determine a UE RX beam pair (i.e., one UE beam for respective UE panel) that optimizes the user throughput (by for example evaluating all different PMIs in a multi-panel codebook for each beam pair). The UE can then feedback CSI information, similar as described above (except the CRI which is not needed in this case since the TRP beams are already decided).

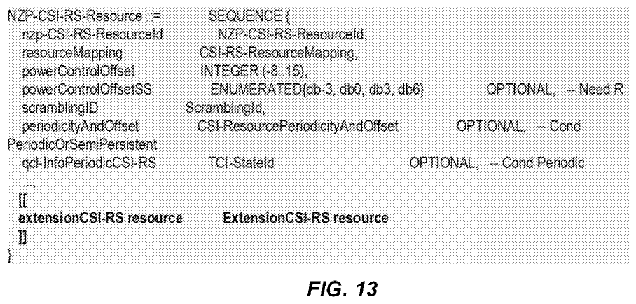

FIG. 11 illustrates an example of UE Rx beam sweep in identifying the best Rx beam for receiving signals from each TRP.

In some of the above descriptions, only two groups of NZP CSI-RS (or SSB) resources are used (hence two TRPs or panels can be used in the method), however, the method is general and applicable to more than two groups of NZP CSI-RS (or SSB) resources (and hence be applicable for more than two TRPs or panels). In this case, the UE not only selects a beam from a TRP, i.e. a resource within a group, but also selects a pair of TRPs.

### NC-JT CSI Feedback with a Set of NZP CSI-RS Resource Tuples

In another preferred embodiment, the UE is configured with a set of NZP-CSI-RS resource tuples. Each entry of the CRI can be configured by RRC or RRC+MAC CE to select one of the NZP CSI-RS resource tuples, in which case only a single CRI is reported for the NC-JT case. In this case, some CRI entries correspond to a single NZP CSI-RS, some correspond to two NZP CSI-RS, and some may correspond to more than two NZP CSI-RS resources. The size of the tuples reflects how many TRPs would be involved in the PDSCH transmissions.

Also, in this case, the UE would report one PMI and one RI per NZP CSI-RS resource, as well as a joint CQI value. For example, if a certain CRI points to a pair of NZP CSI-RS resources, the UE would report two PMIs, and two RIs.

In a further alternative embodiment, if NC-JT CSI reporting is enabled, the UE is configured to associate an entry in the CRI list with an entry in the active TCI state table. For example, a first CRI implies the selection of the NZP CSI-RS(s) of the first entry of the configured TCI state table. Since the entries of the TCI state table are the possible NC-JT transmissions (using single DCI multi-TRP scheduling), these are the only combinations of two NZP CSI-RS resources for channel measurements that are of immediate interest for CSI reporting. This can be seen as the UE is reporting a preferred TCI state in the CSI reporting, among the set of configured TCI states. This embodiment can be combined with the other embodiments by interpreting “CRI” as a “TCI state.”

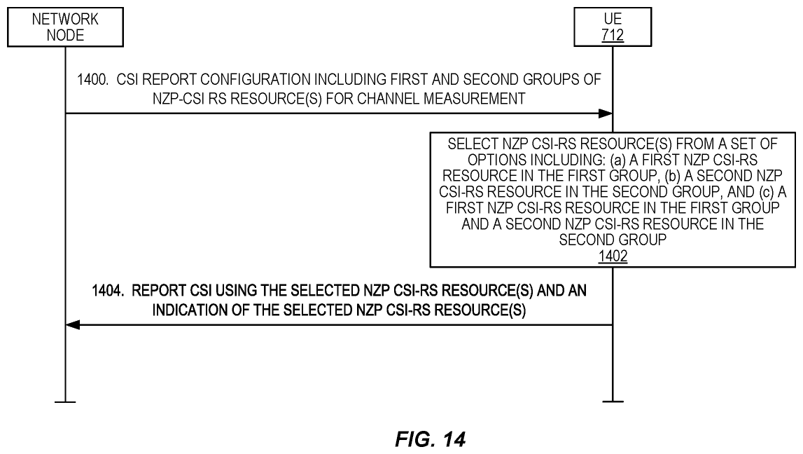

The report size will depend on the preferred CRI: the number of PMI, RI to report directly depends on the size of the tuple indicated by the CRI. Thus, after decoding the CRI, the NW knows the format of the remaining information: there is no need to explicitly indicate how many PMI; CRIs are included in the report. However, to facilitate this, the CRI needs to be separately encoded. Thus, in one embodiment, the report is encoded in two separate parts: the first part contains the CRI and the CQI, and the second part contains the remaining information. See, e.g., FIG. 12.

In one embodiment, these doubles or triples of NZP CSI-RS resources which correspond to the said entry of CRI to be configured by RRC or RRC+MAC CE are configured as elements in an NZP-CSI-RS resource set configured in a CSI-ResourceConfig which is further pointed to in a CSI-ReportConfig. This embodiment assumes existing way of reporting one CRI per NZP-CSI-RS set. This embodiment may be combined with the embodiment that extends the CSI-ResourceConfig with more than one NZP CSI-RS resource set for CSI reporting.

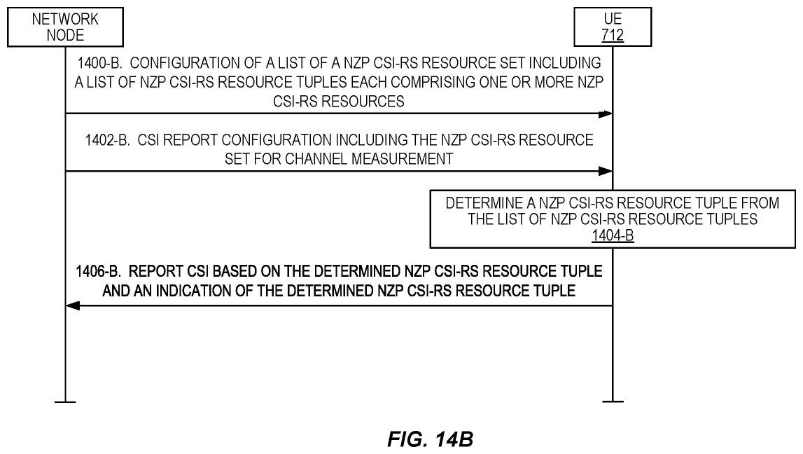

In a related embodiment, the element in the NZP-CSI-RS set is constructed as follows:
One option is to extend the individual NZP-CSI-RS configuration to configure directly an NZP-CSI-RS resource corresponding to the said double, triple or else. One example is shown in FIG. 13 simply marking the bolded text to include the extensions.
In another option, a new NZP-CSI-RS-Resource IE aggregates two or more original NZP-CSI-RS-resources and this is used as an element in the NZP-CSI-RS resource set.

In another embodiment, RRC configures larger set of NZP-CSI-RS resources which here correspond to the configured CRI entries and a MAC CE is used to down select NZP-CSI-RS elements from larger list to the set of size 8 (or something else). The MAC CE would include one of or all following payload fields and possibly some further fields:
Serving cell ID
CSI-ResourceConfig ID
NZP CSI-RS resource set ID
Bitmap to down select N NZP-CSI-RS resources or aggregated resources, i.e. elements of the NZP-CSI-RS resource set.
Field F marking another/or how many NZP CSI-RS resource set ID fields the MAC CE has corresponding to the first NZP CSI-RS resourceConfigID
Field E marking another/or how many NZP CSI-RS Config ID fields the MAC CE has corresponding to the serving cell ID

### Additional Description

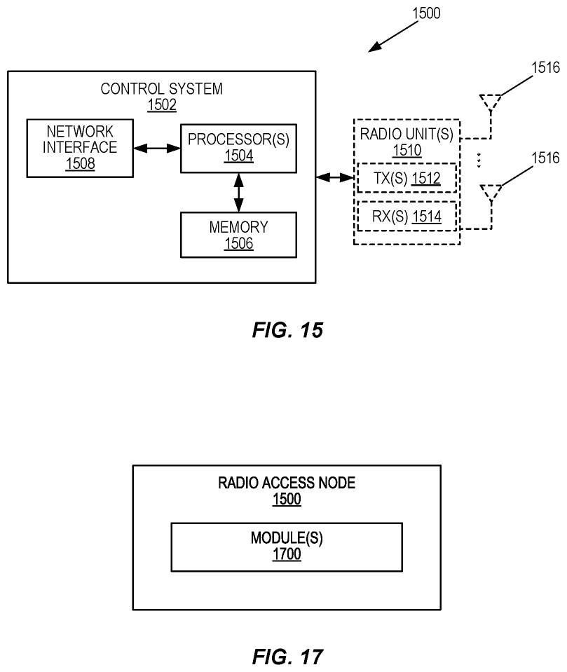

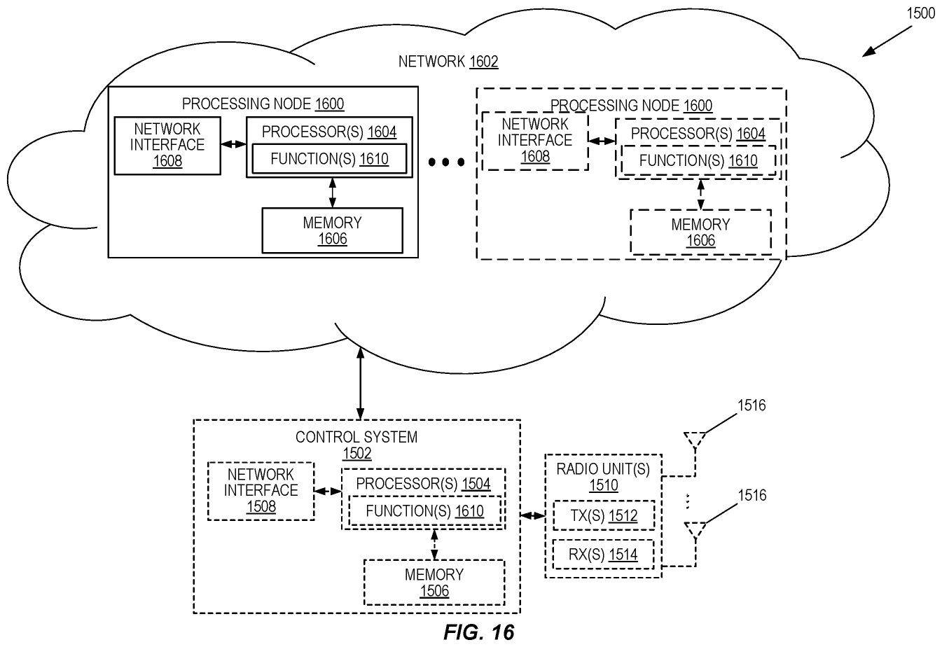

FIG. 14 illustrates the operation of a wireless communication device 712 (e.g., a UE) and network node (e.g., a radio access node 712 such as, e.g., a base station (e.g., gNB)) in accordance with at least some of the embodiments described above. As illustrated, the wireless communication device 712 receives, from the network node, a CSI report configuration that comprises a first group of one or more NZP CSI-RS resources for channel measurement and a second group of one or more NZP CSI-RS resources for channel measurement (step 1400). The wireless communication device 712 selects one or more NZP CSI-RS resources to use for reporting (step 1402). The selected NZP CSI-RS resource(s) is(are) selected from a set of options comprising: (a) a first option consisting of a first NZP CSI-RS resource in the first group, (b) a second option consisting of a second NZP CSI-RS resource in the second group, and (c) a third option consisting of a first NZP CSI-RS resource in the first group and a second NZP CSI-RS resource in the second group. The wireless communication device 712 then reports information comprising CSI based on the selected one or more NZP CSI-RS resources and an indication of the selected NZP CSI-RS resource(s) (step 1404).

While any of the embodiments described above with respect to the aforementioned CSI report configuration, the selection of the NZP CSI-RS resource(s) to use for reporting, and the reporting of the CSI and indication of the selected NZP CSI-RS resource(s) may be used, some examples are described above.

In some embodiments, the first group of one or more NZP CSI-RS resources and the second group of one or more NZP CSI-RS resources correspond to a first NZP CSI-RS resource set and a second NZP CSI-RS resource set, respectively. Further, in some embodiments, the first NZP CSI-RS resource set and the second NZP CSI-RS resource set are configured in two CSI resource settings comprised in the CSI report configuration. In some embodiments, the first NZP CSI-RS resource set and the second NZP CSI-RS resource set are comprised in a single CSI resource setting included the CSI report configuration. Further, in some embodiments, the first NZP CSI-RS resource set and the second NZP CSI-RS resource set comprised in the single CSI resource setting are configured in an aperiodic CSI trigger state associated with the CSI report configuration. In some embodiments, the aperiodic CSI trigger state further contains a first Quasi Co-location, QCL, indication and a second QCL indication for the first NZP CSI-RS resource set and the second NZP CSI-RS resource set, respectively.

In some embodiments, the first group of one or more NZP CSI-RS resources and the second group of one or more NZP CSI-RS resources are contained in a single NZP CSI-RS resource set. In some embodiments, the first group of one or more NZP CSI-RS resources or the second group of one or more NZP CSI-RS resources are identified by an index included in each NZP CSI-RS resource configuration. In some embodiments, the index may be one of: an index of a TCI, a Control Resource Pool Index, or a new group index.

In some embodiments, the wireless communication device 712 selects the NZP CSI-RS resource(s) based on the maximum downlink throughput that can be provided with each option in the set of options.

In some embodiments, the selected one or more NZP CSI-RS resources comprises either the first NZP-CSI resource or the second NZP-CSI resource, and the CSI based on the selected one or more NZP CSI-RS resource comprises one or more of: (a) RI, (b) a PMI, (c) a CQI, (d) a layer one received reference signal power, L1-RSRP, (e) a layer one signal to interference and noise ratio, L1-SINR, (f) a NZP CSI-RS resource indicator, CRI, (g) a NZP CSI-RS resource group indicator, CRGI, or (h) any combination of two or more of (a)-(g).

In some embodiments, the selected NZP CSI-RS resource(s) comprises the first and second NZP CSI-RS resources, and the CSI based on the selected NZP CSI-RS resource(s) comprises a first and a second NZP CSI-RS resource indicator (CRI1, CR2), and associated respectively a first and a second rank indicator, (RI1, RI2), a first and a second precoding matrix indicator (PMI1, PMI2), and a joint channel quality indicator, CQI. In some other embodiments, the selected NZP CSI-RS resource(s) comprises the first and second NZP CSI-RS resources, and the CSI based on the selected NZP CSI-RS resource(s) comprises a first and a second NZP CSI-RS resource indicator (CRI1, CRI2), and associated respectively a first and a second rank indicator, (RI1, RI2), a first and a second precoding matrix indicator (PMI1, PMI2), and a first and a second channel quality indicator (CQI1, CQI2). In some embodiments, the CSI is calculated assuming non-coherent joint transmission (JC-JT) of a PDSCH over antenna ports configured in both the first and the second NZP CSI-RS resources on a same time and frequency resource. In some other embodiments, the CSI based on the selected one or more NZP CSI-RS resources comprises a first and a second NZP CSI-RS resource indicator (CRI1, CRI2), and associated respectively a first and a second RSRP or SINR. In some embodiments, CRI1, CRI2, and/or CRGI may be jointly encoded.

In some embodiments, the indication of the selected one or more NZP CSI-RS resources comprises a RI=0 for the second (or the first) NZP CSI-RS resource.

In some embodiments, the CSI report configuration further includes a code book configuration.

In some embodiments, the CSI report configuration further includes a report quantity indicator indicating CSI report for NC-JT. In some embodiments, the report quantity indicator may further indicate whether the CSI report includes a joint CQI or a pair of CQIs.

In some embodiments, the CSI report configuration further includes one or more CSI-IM resources.

FIG. 14B illustrates the operation of a wireless communication device 712 (e.g., a UE) and network node (e.g., a radio access node 712 such as, e.g., a base station (e.g., gNB)) in accordance with at least some of the embodiments described above. As illustrated, the wireless communication device 712 receives, from the network node, a configuration of a NZP CSI-RS resource set that comprises a list of NZP CSI-RS resource tuples each including one or more NZP CSI-RS resources (step 1400-B). The wireless communication device 712 receives a CSI report configuration including the NZP CSI-RS resource set for channel measurement (step 1402-B). The wireless communication device 712 determines a NZP CSI-RS resource tuple out of the list of NZP CSI-RS resource tuples (step 1404-B) and reports CSI based on the determined NZP CSI-RS resource tuple and an indication of the determined NZP CSI-RS resource tuple (step 1406-B). In one embodiment, the CIS includes a NZP CSI-RS resource tuple indicator (CRTI) and one or more of a RI and a PMI, a L1-RSRP, or L1-SINR for each NZP CSI-RS resource in the tuple, and a joint CQI. Note that the other details described above related to NC-JT CSI feedback with a set of NZP CSI-RS resource tuples are equally applicable here to the process of FIG. 14B.

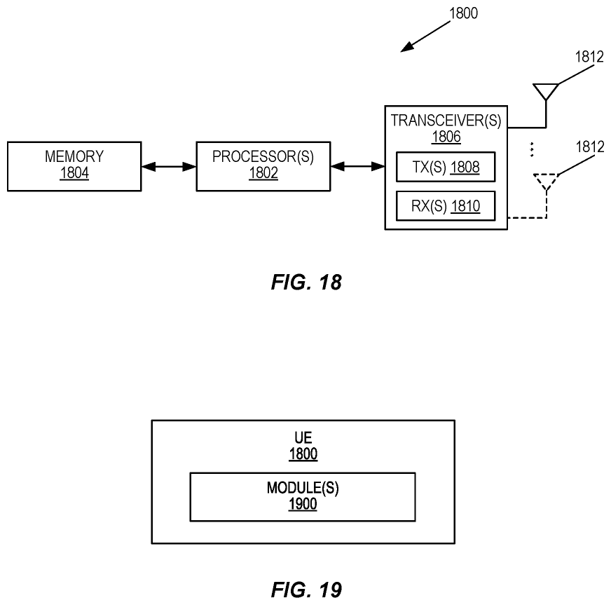

FIG. 15 is a schematic block diagram of a radio access node 1500 according to some embodiments of the present disclosure. Optional features are represented by dashed boxes. The radio access node 1500 may be, for example, a base station 702 or 706 or a network node that implements all or part of the functionality of the base station 702 or gNB described herein. As illustrated, the radio access node 1500 includes a control system 1502 that includes one or more processors 1504 (e.g., Central Processing Units (CPUs), Application Specific Integrated Circuits (ASICs), Field Programmable Gate Arrays (FPGAs), and/or the like), memory 1506, and a network interface 1508. The one or more processors 1504 are also referred to herein as processing circuitry. In addition, the radio access node 1500 may include one or more radio units 1510 that each includes one or more transmitters 1512 and one or more receivers 1514 coupled to one or more antennas 1516. The radio units 1510 may be referred to or be part of radio interface circuitry. In some embodiments, the radio unit(s) 1510 is external to the control system 1502 and connected to the control system 1502 via, e.g., a wired connection (e.g., an optical cable). However, in some other embodiments, the radio unit(s) 1510 and potentially the antenna(s) 1516 are integrated together with the control system 1502. The one or more processors 1504 operate to provide one or more functions of a radio access node 1500 as described herein. In some embodiments, the function(s) are implemented in software that is stored, e.g., in the memory 1506 and executed by the one or more processors 1504.

FIG. 16 is a schematic block diagram that illustrates a virtualized embodiment of the radio access node 1500 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1500 in which at least a portion of the functionality of the radio access node 1500 is implemented as a virtual component(s) (e.g., via a virtual machine(s) executing on a physical processing node(s) in a network(s)). As illustrated, in this example, the radio access node 1500 may include the control system 1502 and/or the one or more radio units 1510, as described above. The control system 1502 may be connected to the radio unit(s) 1510 via, for example, an optical cable or the like. The radio access node 1500 includes one or more processing nodes 1600 coupled to or included as part of a network(s) 1602. If present, the control system 1502 or the radio unit(s) are connected to the processing node(s) 1600 via the network 1602. Each processing node 1600 includes one or more processors 1604 (e.g., CPUs, ASICs, FPGAs, and/or the like), memory 1606, and a network interface 1608.

In this example, functions 1610 of the radio access node 1500 described herein are implemented at the one or more processing nodes 1600 or distributed across the one or more processing nodes 1600 and the control system 1502 and/or the radio unit(s) 1510 in any desired manner. In some particular embodiments, some or all of the functions 1610 of the radio access node 1500 described herein are implemented as virtual components executed by one or more virtual machines implemented in a virtual environment(s) hosted by the processing node(s) 1600. As will be appreciated by one of ordinary skill in the art, additional signaling or communication between the processing node(s) 1600 and the control system 1502 is used in order to carry out at least some of the desired functions 1610. Notably, in some embodiments, the control system 1502 may not be included, in which case the radio unit(s) 1510 communicate directly with the processing node(s) 1600 via an appropriate network interface(s).

In some embodiments, a computer program including instructions which, when executed by at least one processor, causes the at least one processor to carry out the functionality of radio access node 1500 or a node (e.g., a processing node 1600) implementing one or more of the functions 1610 of the radio access node 1500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 17 is a schematic block diagram of the radio access node 1500 according to some other embodiments of the present disclosure. The radio access node 1500 includes one or more modules 1700, each of which is implemented in software. The module(s) 1700 provide the functionality of the radio access node 1500 described herein. This discussion is equally applicable to the processing node 1600 of FIG. 16 where the modules 1700 may be implemented at one of the processing nodes 1600 or distributed across multiple processing nodes 1600 and/or distributed across the processing node(s) 1600 and the control system 1502.

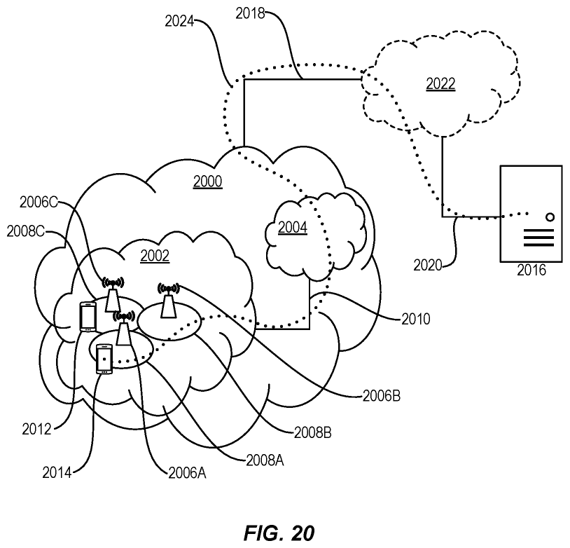

FIG. 18 is a schematic block diagram of a wireless communication device 1800 according to some embodiments of the present disclosure. As illustrated, the wireless communication device 1800 includes one or more processors 1802 (e.g., CPUs, ASICs, FPGAs, and/or the like), memory 1804, and one or more transceivers 1806 each including one or more transmitters 1808 and one or more receivers 1810 coupled to one or more antennas 1812. The transceiver(s) 1806 includes radio-front end circuitry connected to the antenna(s) 1812 that is configured to condition signals communicated between the antenna(s) 1812 and the processor(s) 1802, as will be appreciated by on of ordinary skill in the art. The processors 1802 are also referred to herein as processing circuitry. The transceivers 1806 are also referred to herein as radio circuitry. In some embodiments, the functionality of the wireless communication device 1800 described above (e.g., functionality of a UE) may be fully or partially implemented in software that is, e.g., stored in the memory 1804 and executed by the processor(s) 1802. Note that the wireless communication device 1800 may include additional components not illustrated in FIG. 18 such as, e.g., one or more user interface components (e.g., an input/output interface including a display, buttons, a touch screen, a microphone, a speaker(s), and/or the like and/or any other components for allowing input of information into the wireless communication device 1800 and/or allowing output of information from the wireless communication device 1800), a power supply (e.g., a battery and associated power circuitry), etc.

In some embodiments, a computer program including instructions which, when executed by at least one processor, causes the at least one processor to carry out the functionality of the wireless communication device 1800 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 19 is a schematic block diagram of the wireless communication device 1800 according to some other embodiments of the present disclosure. The wireless communication device 1800 includes one or more modules 1900, each of which is implemented in software. The module(s) 1900 provide the functionality of the wireless communication device 1800 described herein.

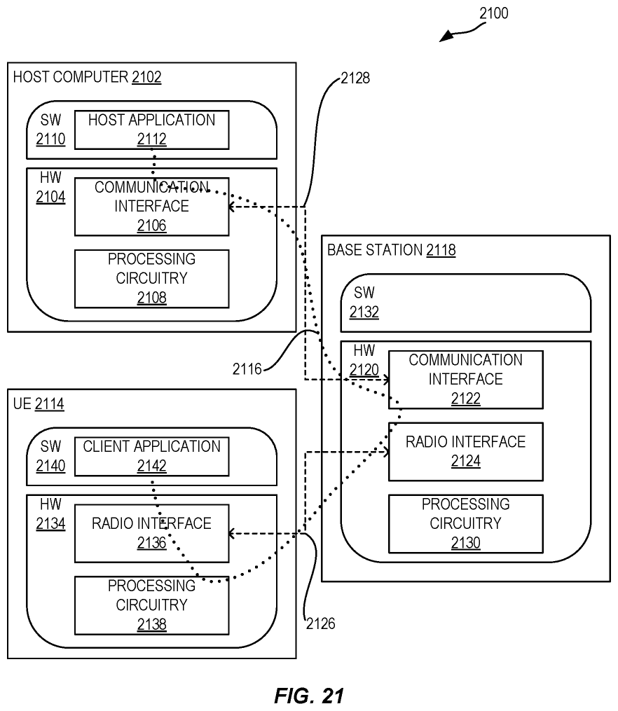

With reference to FIG. 20, in accordance with an embodiment, a communication system includes a telecommunication network 2000, such as a 3GPP-type cellular network, which comprises an access network 2002, such as a RAN, and a core network 2004. The access network 2002 comprises a plurality of base stations 2006A, 2006B, 2006C, such as Node Bs, eNBs, gNBs, or other types of wireless Access Points (APs), each defining a corresponding coverage area 2008A, 2008B, 2008C. Each base station 2006A, 2006B, 2006C is connectable to the core network 2004 over a wired or wireless connection 2010. A first UE 2012 located in coverage area 2008C is configured to wirelessly connect to, or be paged by, the corresponding base station 2006C. A second UE 2014 in coverage area 2008A is wirelessly connectable to the corresponding base station 2006A. While a plurality of UEs 2012, 2014 are illustrated in this example, the disclosed embodiments are equally applicable to a situation where a sole UE is in the coverage area or where a sole UE is connecting to the corresponding base station 2006.

The telecommunication network 2000 is itself connected to a host computer 2016, which may be embodied in the hardware and/or software of a standalone server, a cloud-implemented server, a distributed server, or as processing resources in a server farm. The host computer 2016 may be under the ownership or control of a service provider, or may be operated by the service provider or on behalf of the service provider. Connections 2018 and 2020 between the telecommunication network 2000 and the host computer 2016 may extend directly from the core network 2004 to the host computer 2016 or may go via an optional intermediate network 2022. The intermediate network 2022 may be one of, or a combination of more than one of, a public, private, or hosted network; the intermediate network 2022, if any, may be a backbone network or the Internet; in particular, the intermediate network 2022 may comprise two or more sub-networks (not shown).

The communication system of FIG. 20 as a whole enables connectivity between the connected UEs 2012, 2014 and the host computer 2016. The connectivity may be described as an Over-the-Top (OTT) connection 2024. The host computer 2016 and the connected UEs 2012, 2014 are configured to communicate data and/or signaling via the OTT connection 2024, using the access network 2002, the core network 2004, any intermediate network 2022, and possible further infrastructure (not shown) as intermediaries. The OTT connection 2024 may be transparent in the sense that the participating communication devices through which the OTT connection 2024 passes are unaware of routing of uplink and downlink communications. For example, the base station 2006 may not or need not be informed about the past routing of an incoming downlink communication with data originating from the host computer 2016 to be forwarded (e.g., handed over) to a connected UE 2012. Similarly, the base station 2006 need not be aware of the future routing of an outgoing uplink communication originating from the UE 2012 towards the host computer 2016.

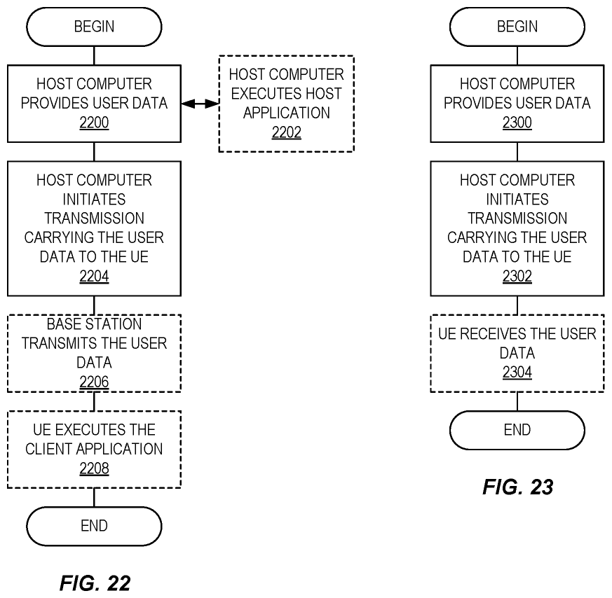

Example implementations, in accordance with an embodiment, of the UE, base station, and host computer discussed in the preceding paragraphs will now be described with reference to FIG. 21. In a communication system 2100, a host computer 2102 comprises hardware 2104 including a communication interface 2106 configured to set up and maintain a wired or wireless connection with an interface of a different communication device of the communication system 2100. The host computer 2102 further comprises processing circuitry 2108, which may have storage and/or processing capabilities. In particular, the processing circuitry 2108 may comprise one or more programmable processors, ASICs, FPGAs, or combinations of these (not shown) adapted to execute instructions. The host computer 2102 further comprises software 2110, which is stored in or accessible by the host computer 2102 and executable by the processing circuitry 2108. The software 2110 includes a host application 2112. The host application 2112 may be operable to provide a service to a remote user, such as a UE 2114 connecting via an OTT connection 2116 terminating at the UE 2114 and the host computer 2102. In providing the service to the remote user, the host application 2112 may provide user data which is transmitted using the OTT connection 2116.

The communication system 2100 further includes a base station 2118 provided in a telecommunication system and comprising hardware 2120 enabling it to communicate with the host computer 2102 and with the UE 2114. The hardware 2120 may include a communication interface 2122 for setting up and maintaining a wired or wireless connection with an interface of a different communication device of the communication system 2100, as well as a radio interface 2124 for setting up and maintaining at least a wireless connection 2126 with the UE 2114 located in a coverage area (not shown in FIG. 21) served by the base station 2118. The communication interface 2122 may be configured to facilitate a connection 2128 to the host computer 2102. The connection 2128 may be direct or it may pass through a core network (not shown in FIG. 21) of the telecommunication system and/or through one or more intermediate networks outside the telecommunication system. In the embodiment shown, the hardware 2120 of the base station 2118 further includes processing circuitry 2130, which may comprise one or more programmable processors, ASICs, FPGAs, or combinations of these (not shown) adapted to execute instructions. The base station 2118 further has software 2132 stored internally or accessible via an external connection.

The communication system 2100 further includes the UE 2114 already referred to. The UE's 2114 hardware 2134 may include a radio interface 2136 configured to set up and maintain a wireless connection 2126 with a base station serving a coverage area in which the UE 2114 is currently located. The hardware 2134 of the UE 2114 further includes processing circuitry 2138, which may comprise one or more programmable processors, ASICs, FPGAs, or combinations of these (not shown) adapted to execute instructions. The UE 2114 further comprises software 2140, which is stored in or accessible by the UE 2114 and executable by the processing circuitry 2138. The software 2140 includes a client application 2142. The client application 2142 may be operable to provide a service to a human or non-human user via the UE 2114, with the support of the host computer 2102. In the host computer 2102, the executing host application 2112 may communicate with the executing client application 2142 via the OTT connection 2116 terminating at the UE 2114 and the host computer 2102. In providing the service to the user, the client application 2142 may receive request data from the host application 2112 and provide user data in response to the request data. The OTT connection 2116 may transfer both the request data and the user data. The client application 2142 may interact with the user to generate the user data that it provides.

It is noted that the host computer 2102, the base station 2118, and the UE 2114 illustrated in FIG. 21 may be similar or identical to the host computer 2016, one of the base stations 2006A, 2006B, 2006C, and one of the UEs 2012, 2014 of FIG. 20, respectively. This is to say, the inner workings of these entities may be as shown in FIG. 21 and independently, the surrounding network topology may be that of FIG. 20.

In FIG. 21, the OTT connection 2116 has been drawn abstractly to illustrate the communication between the host computer 2102 and the UE 2114 via the base station 2118 without explicit reference to any intermediary devices and the precise routing of messages via these devices. The network infrastructure may determine the routing, which may be configured to hide from the UE 2114 or from the service provider operating the host computer 2102, or both. While the OTT connection 2116 is active, the network infrastructure may further take decisions by which it dynamically changes the routing (e.g., on the basis of load balancing consideration or reconfiguration of the network).

The wireless connection 2126 between the UE 2114 and the base station 2118 is in accordance with the teachings of the embodiments described throughout this disclosure. One or more of the various embodiments improve the performance of OTT services provided to the UE 2114 using the OTT connection 2116, in which the wireless connection 2126 forms the last segment.

A measurement procedure may be provided for the purpose of monitoring data rate, latency, and other factors on which the one or more embodiments improve. There may further be an optional network functionality for reconfiguring the OTT connection 2116 between the host computer 2102 and the UE 2114, in response to variations in the measurement results. The measurement procedure and/or the network functionality for reconfiguring the OTT connection 2116 may be implemented in the software 2110 and the hardware 2104 of the host computer 2102 or in the software 2140 and the hardware 2134 of the UE 2114, or both. In some embodiments, sensors (not shown) may be deployed in or in association with communication devices through which the OTT connection 2116 passes; the sensors may participate in the measurement procedure by supplying values of the monitored quantities exemplified above, or supplying values of other physical quantities from which the software 2110, 2140 may compute or estimate the monitored quantities. The reconfiguring of the OTT connection 2116 may include message format, retransmission settings, preferred routing, etc.; the reconfiguring need not affect the base station 2118, and it may be unknown or imperceptible to the base station 2118. Such procedures and functionalities may be known and practiced in the art. In certain embodiments, measurements may involve proprietary UE signaling facilitating the host computer 2102's measurements of throughput, propagation times, latency, and the like. The measurements may be implemented in that the software 2110 and 2140 causes messages to be transmitted, in particular empty or ‘dummy’ messages, using the OTT connection 2116 while it monitors propagation times, errors, etc.

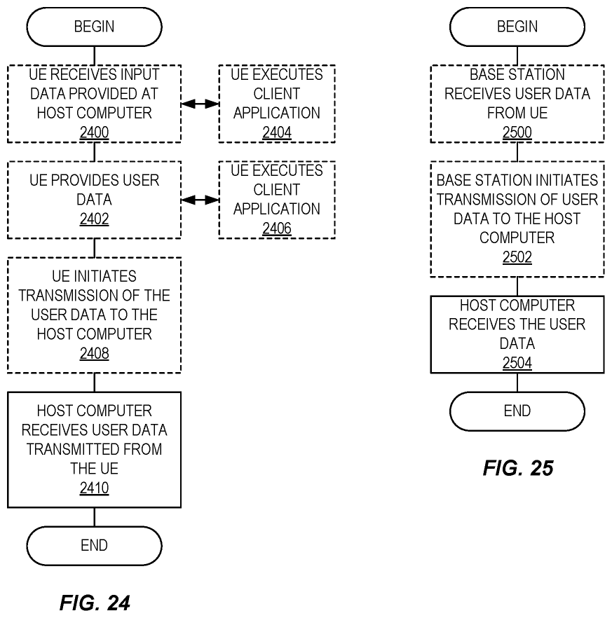

FIG. 22 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 22 will be included in this section. In step 2200, the host computer provides user data. In sub-step 2202 (which may be optional) of step 2200, the host computer provides the user data by executing a host application. In step 2204, the host computer initiates a transmission carrying the user data to the UE. In step 2206 (which may be optional), the base station transmits to the UE the user data which was carried in the transmission that the host computer initiated, in accordance with the teachings of the embodiments described throughout this disclosure. In step 2208 (which may also be optional), the UE executes a client application associated with the host application executed by the host computer.

FIG. 23 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 23 will be included in this section. In step 2300 of the method, the host computer provides user data. In an optional sub-step (not shown) the host computer provides the user data by executing a host application. In step 2302, the host computer initiates a transmission carrying the user data to the UE. The transmission may pass via the base station, in accordance with the teachings of the embodiments described throughout this disclosure. In step 2304 (which may be optional), the UE receives the user data carried in the transmission.

FIG. 24 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 24 will be included in this section. In step 2400 (which may be optional), the UE receives input data provided by the host computer. Additionally or alternatively, in step 2402, the UE provides user data. In sub-step 2404 (which may be optional) of step 2400, the UE provides the user data by executing a client application. In sub-step 2406 (which may be optional) of step 2402, the UE executes a client application which provides the user data in reaction to the received input data provided by the host computer. In providing the user data, the executed client application may further consider user input received from the user. Regardless of the specific manner in which the user data was provided, the UE initiates, in sub-step 2408 (which may be optional), transmission of the user data to the host computer. In step 2410 of the method, the host computer receives the user data transmitted from the UE, in accordance with the teachings of the embodiments described throughout this disclosure.

FIG. 25 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 25 will be included in this section. In step 2500 (which may be optional), in accordance with the teachings of the embodiments described throughout this disclosure, the base station receives user data from the UE. In step 2502 (which may be optional), the base station initiates transmission of the received user data to the host computer. In step 2504 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Group A Embodiments

Embodiment 1: A method performed by a wireless communication device for reporting Channel State Information, CSI, in a wireless network, the method comprising one or more of the following:
receiving (1400) a CSI report configuration that comprises a first group of one or more None Zero Power CSI reference signal, NZP CSI-RS, resources for channel measurement and a second group of one or more NZP CSI-RS resources for channel measurement; and
selecting (1402) one or more NZP CSI-RS resources to use for reporting, the selected one or more NZP CSI-RS resources being select from a set of options comprising:
   a first option consisting of a first NZP CSI-RS resource in the first group;
   a second option consisting of a second NZP CSI-RS resource in the second group; and
   a third option consisting of a first NZP CSI-RS resource in the first group and a second NZP CSI-RS resource in the second group; and
reporting (1404) information comprising:
CSI based on the selected one or more NZP CSI-RS resources; and
an indication of the selected one or more NZP CSI-RS resources.

Embodiment 2: The method of embodiment 1, wherein the first group of one or more NZP CSI-RS resources and the second group of one or more NZP CSI-RS resources correspond to a first NZP CSI-RS resource set and a second NZP CSI-RS resource set, respectively.

Embodiment 3: The method of embodiment 2, wherein the first NZP CSI-RS resource set and the second NZP CSI-RS resource set are configured in two CSI resource settings comprised in the CSI report configuration.

Embodiment 4: The method of embodiment 2, wherein the first NZP CSI-RS resource set and the second NZP CSI-RS resource set are comprised in a single CSI resource setting included the CSI report configuration.

Embodiment 5: The method of embodiment 4, wherein the first NZP CSI-RS resource set and the second NZP CSI-RS resource set comprised in the single CSI resource setting are configured in an aperiodic CSI trigger state associated with the CSI report configuration.

Embodiment 6: The method of embodiment 5, wherein the aperiodic CSI trigger state further contains a first Quasi Co-location, QCL, indication and a second QCL indication for the first NZP CSI-RS resource set and the second NZP CSI-RS resource set, respectively.

Embodiment 7: The method of embodiment 1, wherein the first group of one or more NZP CSI-RS resources and the second group of one or more NZP CSI-RS resources are contained in a single NZP CSI-RS resource set.

Embodiment 8: The method of embodiment 7, wherein the first group of one or more NZP CSI-RS resources or the second group of one or more NZP CSI-RS resources are identified by an index included in each NZP CSI-RS resource configuration.

Embodiment 9: The method of embodiment 8, wherein the index may be one of: an index of a transmission configuration indicator, TCI; or a Control Resource Pool Index; or a new group index.

Embodiment 10: The method of any of embodiments 1 to 9, wherein selecting the one or more NZP CSI-RS resources comprises selecting the one or more NZP CSI-RS resources based on the maximum downlink throughput that can be provided with each option in the set of options.

Embodiment 11: The method of any of embodiments 1 to 10, wherein the selected one or more NZP CSI-RS resources comprises either the first NZP-CSI resource or the second NZP-CSI resource, and the CSI based on the selected one or more NZP CSI-RS resource comprises one or more of: (a) a rank indicator, RI; (b) a precoding matrix indicator, PMI; (c) a channel quality indicator, CQI; (d) a layer one received reference signal power, L1-RSRP; (e) a layer one signal to interference and noise ratio, L1-SINR; (f) a NZP CSI-RS resource indicator, CRI; (g) a NZP CSI-RS resource group indicator, CRGI; or (h) any combination of two or more of (a)-(g).

Embodiment 12: The method of any of embodiments 1 to 10, wherein the selected one or more NZP CSI-RS resources comprises the first and second NZP CSI-RS resources, and the CSI based on the selected one or more NZP CSI-RS resources comprises a first and a second NZP CSI-RS resource indicator (CRI1, CR2), and associated respectively a first and a second rank indicator, (RI1, RI2), a first and a second precoding matrix indicator (PMI1, PMI2), and a joint channel quality indicator, CQI.

Embodiment 13: The method of any of embodiments 1 to 10, wherein the selected one or more NZP CSI-RS resources comprises the first and second NZP CSI-RS resources, and the CSI based on the selected one or more NZP CSI-RS resources comprises a first and a second NZP CSI-RS resource indicator (CRI1, CRI2), and associated respectively a first and a second rank indicator, (RI1, RI2), a first and a second precoding matrix indicator (PMI1, PMI2), and a first and a second channel quality indicator (CQI1, CQI2).

Embodiment 14: The method of any of embodiments 12 to 13, wherein the CSI is calculated assuming non-coherent joint transmission, JC-JT, of a physical downlink shared channel, PDSCH, over antenna ports configured in both the first and the second NZP CSI-RS resources on a same time and frequency resource.

Embodiment 15: The method of any of embodiments 1 to 10, wherein the CSI based on the selected one or more NZP CSI-RS resources comprises a first and a second NZP CSI-RS resource indicator (CRI1, CRI2), and associated respectively a first and a second RSRP or SINR.

Embodiment 16: The method of embodiments 11 to 15, wherein CRI1, CRI2, and/or CRGI may be jointly encoded.

Embodiment 17: The method of embodiments 11 to 15, wherein the indication of the selected one or more NZP CSI-RS resources comprises a RI=0 for the second (or the first) NZP CSI-RS resource.

Embodiment 18: The method of any of embodiments 1 to 17, wherein the CSI report configuration further includes a code book configuration.

Embodiment 19: The method of any of embodiments 1 to 18, wherein the CSI report configuration further includes a report quantity indicator indicating CSI report for NC-JT.

Embodiment 20: The method of embodiments 1 to 18, wherein the report quantity indicator may further indicate whether the CSI report includes a joint CQI or a pair of CQIs.

Embodiment 21: The method of embodiments 1 to 18, wherein the CSI report configuration further includes one or more CSI interference measurement, CSI-IM, resources.

Embodiment 22: A method performed by a wireless device for reporting Channel State Information, CSI in a wireless network, the method comprising one or more of the following: receiving a configuration of a Non Zero Power CSI reference signal, NZP CSI-RS, resource set comprising a list of NZP CSI-RS resource tuples each including one or more NZP CSI-RS resources; receiving a CSI report configuration including the NZP CSI-RS resource set for channel measurement; determining an NZP CSI-RS resource tuple out of the list of NZP CSI-RS resource tuples; and reporting CSI based on the determined NZP CSI-RS resource tuple, and an indication of the determined NZP CSI-RS resource tuple.

Embodiment 23: The method of embodiment 22, wherein the CSI includes an NZP CSI-RS resource tuple indicator, CRTI, and one or more of a RI and a PMI, a L1-RSRP, or L1-SINR for each NZP CSI-RS resource in the tuple, and a joint CQI.

Embodiment 24: The method of any of the previous embodiments, further comprising: providing user data; and forwarding the user data to a host computer via the transmission to the base station.

### Group B Embodiments

Embodiment 25: A method performed by a base station, the method comprising one or more of the following:
providing (1400), to a wireless communication device, a CSI report configuration that comprises a first group of one or more None Zero Power CSI reference signal, NZP CSI-RS, resources for channel measurement and a second group of one or more NZP CSI-RS resources for channel measurement; and
receiving (1404), from the wireless communication device, information comprising:
CSI based on a selected one or more NZP CSI-RS resources, the selected one or more NZP CSI-RS resources being select from a set of options comprising:
   a first option consisting of a first NZP CSI-RS resource in the first group;
   a second option consisting of a second NZP CSI-RS resource in the second group; and
   a third option consisting of a first NZP CSI-RS resource in the first group and a second NZP CSI-RS resource in the second group; and
an indication of the selected one or more NZP CSI-RS resources.

Embodiment 26: The method of embodiment 25, wherein the first group of one or more NZP CSI-RS resources and the second group of one or more NZP CSI-RS resources correspond to a first NZP CSI-RS resource set and a second NZP CSI-RS resource set, respectively.

Embodiment 27: The method of embodiment 26, wherein the first NZP CSI-RS resource set and the second NZP CSI-RS resource set are configured in two CSI resource settings comprised in the CSI report configuration.

Embodiment 28: The method of embodiment 26, wherein the first NZP CSI-RS resource set and the second NZP CSI-RS resource set are comprised in a single CSI resource setting included the CSI report configuration.

Embodiment 29: The method of embodiment 28, wherein the first NZP CSI-RS resource set and the second NZP CSI-RS resource set comprised in the single CSI resource setting are configured in an aperiodic CSI trigger state associated with the CSI report configuration.

Embodiment 30: The method of embodiment 29, wherein the aperiodic CSI trigger state further contains a first Quasi Co-location, QCL, indication and a second QCL indication for the first NZP CSI-RS resource set and the second NZP CSI-RS resource set, respectively.

Embodiment 31: The method of embodiment 25, wherein the first group of one or more NZP CSI-RS resources and the second group of one or more NZP CSI-RS resources are contained in a single NZP CSI-RS resource set.

Embodiment 32: The method of embodiment 31, wherein the first group of one or more NZP CSI-RS resources or the second group of one or more NZP CSI-RS resources are identified by an index included in each NZP CSI-RS resource configuration.

Embodiment 33: The method of embodiment 32, wherein the index may be one of: an index of a transmission configuration indicator, TCI; or a Control Resource Pool Index; or a new group index.

Embodiment 34: The method of any of embodiments 25 to 33, wherein the selected one or more NZP CSI-RS resources comprises either the first NZP-CSI resource or the second NZP-CSI resource, and the CSI based on the selected one or more NZP CSI-RS resource comprises one or more of: (a) a rank indicator, RI; (b) a precoding matrix indicator, PMI; (c) a channel quality indicator, CQI; (d) a layer one received reference signal power, L1-RSRP; (e) a layer one signal to interference and noise ratio, L1-SINR; (f) a NZP CSI-RS resource indicator, CRI; (g) a NZP CSI-RS resource group indicator, CRGI; or (h) any combination of two or more of (a)-(g).

Embodiment 35: The method of any of embodiments 25 to 33, wherein the selected one or more NZP CSI-RS resources comprises the first and second NZP CSI-RS resources, and the CSI based on the selected one or more NZP CSI-RS resources comprises a first and a second NZP CSI-RS resource indicator (CRI1, CR2), and associated respectively a first and a second rank indicator, (RI1, RI2), a first and a second precoding matrix indicator (PMI1, PMI2), and a joint channel quality indicator, CQI.

Embodiment 36: The method of any of embodiments 25 to 33, wherein the selected one or more NZP CSI-RS resources comprises the first and second NZP CSI-RS resources, and the CSI based on the selected one or more NZP CSI-RS resources comprises a first and a second NZP CSI-RS resource indicator (CRI1, CRI2), and associated respectively a first and a second rank indicator, (RI1, RI2), a first and a second precoding matrix indicator (PMI1, PMI2), and a first and a second channel quality indicator (CQI1, CQI2).

Embodiment 37: The method of any of embodiments 35 to 36, wherein the CSI is calculated assuming non-coherent joint transmission, JC-JT, of a physical downlink shared channel, PDSCH, over antenna ports configured in both the first and the second NZP CSI-RS resources on a same time and frequency resource.

Embodiment 38: The method of any of embodiments 25 to 33, wherein the CSI based on the selected one or more NZP CSI-RS resources comprises a first and a second NZP CSI-RS resource indicator (CRI1, CRI2), and associated respectively a first and a second RSRP or SINR.

Embodiment 39: The method of embodiments 34 to 38, wherein CRI1, CRI2, and/or CRGI may be jointly encoded.

Embodiment 40: The method of embodiments 34 to 38, wherein the indication of the selected one or more NZP CSI-RS resources comprises a RI=0 for the second (or the first) NZP CSI-RS resource.

Embodiment 41: The method of any of embodiments 25 to 40, wherein the CSI report configuration further includes a code book configuration.

Embodiment 42: The method of any of embodiments 25 to 41, wherein the CSI report configuration further includes a report quantity indicator indicating CSI report for NC-JT.

Embodiment 43: The method of embodiments 25 to 41, wherein the report quantity indicator may further indicate whether the CSI report includes a joint CQI or a pair of CQIs.

Embodiment 44: The method of embodiments 25 to 41, wherein the CSI report configuration further includes one or more CSI interference measurement, CSI-IM, resources.

Embodiment 45: A method performed by a base station, the method comprising one or more of the following: providing, to a wireless communication device, a configuration of a Non Zero Power CSI reference signal, NZP CSI-RS, resource set comprising a list of NZP CSI-RS resource tuples each including one or more NZP CSI-RS resources; providing, to the wireless communication device, a CSI report configuration including the NZP CSI-RS resource set for channel measurement; and receiving, from the wireless communication device, CSI based on the determined NZP CSI-RS resource tuple, and an indication of the determined NZP CSI-RS resource tuple.

Embodiment 46: The method of embodiment 45, wherein the CSI includes an NZP CSI-RS resource tuple indicator, CRTI, and one or more of a RI and a PMI, a L1-RSRP, or L1-SINR for each NZP CSI-RS resource in the tuple, and a joint CQI.

Embodiment 47: The method of any of the previous embodiments, further comprising: obtaining user data; and forwarding the user data to a host computer or a wireless device.

### Group C Embodiments

Embodiment 48: A wireless device comprising: processing circuitry configured to perform any of the steps of any of the Group A embodiments; and power supply circuitry configured to supply power to the wireless device.

Embodiment 49: A base station comprising: processing circuitry configured to perform any of the steps of any of the Group B embodiments; and power supply circuitry configured to supply power to the base station.

Embodiment 50: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 51: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 52: The communication system of the previous embodiment further including the base station.

Embodiment 53: The communication system of the previous 2 embodiments, further including the UE, wherein the UE is configured to communicate with the base station.

Embodiment 54: The communication system of the previous 3 embodiments, wherein: the processing circuitry of the host computer is configured to execute a host application, thereby providing the user data; and the UE comprises processing circuitry configured to execute a client application associated with the host application.

Embodiment 55: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 56: The method of the previous embodiment, further comprising, at the base station, transmitting the user data.

Embodiment 57: The method of the previous 2 embodiments, wherein the user data is provided at the host computer by executing a host application, the method further comprising, at the UE, executing a client application associated with the host application.

Embodiment 58: A User Equipment, UE, configured to communicate with a base station, the UE comprising a radio interface and processing circuitry configured to perform the method of the previous 3 embodiments.

Embodiment 59: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 60: The communication system of the previous embodiment, wherein the cellular network further includes a base station configured to communicate with the UE.

Embodiment 61: The communication system of the previous 2 embodiments, wherein: the processing circuitry of the host computer is configured to execute a host application, thereby providing the user data; and the UE's processing circuitry is configured to execute a client application associated with the host application.

Embodiment 62: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 63: The method of the previous embodiment, further comprising at the UE, receiving the user data from the base station.

Embodiment 64: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 65: The communication system of the previous embodiment, further including the UE.

Embodiment 66: The communication system of the previous 2 embodiments, further including the base station, wherein the base station comprises a radio interface configured to communicate with the UE and a communication interface configured to forward to the host computer the user data carried by a transmission from the UE to the base station.

Embodiment 67: The communication system of the previous 3 embodiments, wherein: the processing circuitry of the host computer is configured to execute a host application; and the UE's processing circuitry is configured to execute a client application associated with the host application, thereby providing the user data.

Embodiment 68: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 69: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 70: The method of the previous embodiment, further comprising, at the UE, providing the user data to the base station.

Embodiment 71: The method of the previous 2 embodiments, further comprising: at the UE, executing a client application, thereby providing the user data to be transmitted; and at the host computer, executing a host application associated with the client application.

Embodiment 72: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 73: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 74: The communication system of the previous embodiment further including the base station.

Embodiment 75: The communication system of the previous 2 embodiments, further including the UE, wherein the UE is configured to communicate with the base station.

Embodiment 76: The communication system of the previous 3 embodiments, wherein: the processing circuitry of the host computer is configured to execute a host application; and the UE is configured to execute a client application associated with the host application, thereby providing the user data to be received by the host computer.

Embodiment 77: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 78: The method of the previous embodiment, further comprising at the base station, receiving the user data from the UE.

Embodiment 79: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a wireless communication device for reporting Channel State Information, CSI, in a wireless network, the method comprising:
receiving a CSI report configuration that comprises either:
a first group of one or more Non-Zero Power CSI reference signal, NZP CSI-RS, resources for channel measurement and a second group of one or more NZP CSI-RS resources for channel measurement; or
a list of NZP CSI-RS resource tuples each comprising one or more NZP CSI-RS resources for channel measurement; and
selecting a first NZP CSI-RS resource and/or a second NZP CSI-RS resources in the first group of one or more NZP CSI-RS resources and/or the second group of one or more NZP CSI-RS resources, respectively, or in a NZP CSI-RS resource tuple in the list of NZP CSI-RS resource tuples; and
reporting, to a network node, information comprising CSI based on the first NZP CSI-RS resource and/or the second NZP CSI-RS resources.

2. The method of claim 1, wherein the first group of one or more NZP CSI-RS resources and the second group of one or more NZP CSI-RS resources are associated with a first transmission and reception point, TRP, and a second TRP, respectively.

3. The method of claim 1, wherein each of the list of NZP CSI-RS resource tuples comprises one NZP CSI-RS resource associated with a first transmission and reception point, TRP, and another NZP CSI-RS resource associated with a second TRP.

4. The method of claim 1, wherein the reported information further comprises an indication of the selected first NZP CSI-RS resource and/or second NZP CSI-RS resources.

5. The method of claim 1, wherein:
selecting the first NZP CSI-RS resource and/or the second NZP CSI-RS resources comprises selecting the first NZP CSI-RS resource and the second NZP CSI-RS resource, and the CSI is CSI corresponding to non-coherent joint transmission, NC-JT, associated with the first NZP CSI-RS resource and the second NZP CSI-RS resource,
the CSI is CSI corresponding to non-coherent joint transmission, NC-JT, associated with the NZP CSI-RS tuple,
selecting the first NZP CSI-RS resource and/or the second NZP CSI-RS resources comprises selecting the first NZP CSI-RS resource or the second NZP CSI-RS resource, and the CSI is CSI corresponding to the selected first or second NZP CSI-RS resource,
the CSI is reference signal received power, RSRP, associated with each of the selected first and/or second NZP CSI-RS resources, or
the CSI is signal to interference and noise ratio, SINR, associated with each of the selected first and/or the second NZP CSI-RS resources.

6. The method of claim 1, wherein the first group of one or more NZP CSI-RS resources and the second group of one or more NZP CSI-RS resources correspond to a first NZP CSI-RS resource set and a second NZP CSI-RS resource set, respectively.

7. The method of claim 6, wherein the first NZP CSI-RS resource set and the second NZP CSI-RS resource set are configured in two CSI resource settings comprised in the CSI report configuration.

8. The method of claim 7 wherein the wireless network is a New Radio, NR, network, the CSI report configuration is a CSI-ReportConfig that is extended to contain two resourcesForChannelMeasurment pointing to the first and second NZP CSI-RS resource sets, respectively.

9. The method of claim 7 wherein the wireless network is a New Radio, NR, network, the CSI report configuration is a CSI-ReportConfig a first of the two CSI resource settings is a first resourcesForChannelMeasurment comprised within the CSI-ReportConfig that points to the first NZP CSI-RS resource set, and a second of the two CSI resource settings is a second resourcesForChannelMeasurment comprised within the CSI-ReportConfig that points to the second NZP CSI-RS resource set.

10. The method of claim 6 wherein the wireless network is a New Radio, NR, network, the reporting is an aperiodically triggered CSI report, and the first and second NZP CSI-RS resource sets are indicated per CSI-AssociatedReportConfigInfo in a CSI-AperiodicTriggerStateList information element.

11. The method of claim 6, wherein the first NZP CSI-RS resource set and the second NZP CSI-RS resource set are comprised in a single CSI resource setting included the CSI report configuration.

12. The method of claim 11, wherein the first NZP CSI-RS resource set and the second NZP CSI-RS resource set comprised in the single CSI resource setting are configured in an aperiodic CSI trigger state associated with the CSI report configuration.

13. The method of claim 12, wherein the aperiodic CSI trigger state further contains a first Quasi Co-location, QCL, indication and a second QCL indication for the first NZP CSI-RS resource set and the second NZP CSI-RS resource set, respectively.

14. The method of claim 1, 2, 4, or 5, wherein the first group of one or more NZP CSI-RS resources and the second group of one or more NZP CSI-RS resources are contained in a single NZP CSI-RS resource set.

15. The method of claim 14, wherein each NZP CSI-RS resource in the first and second groups is associated with an index that indicates whether the NZP CSI-RS resource is in the first or the second group.

16. The method of claim 14, wherein the first group of one or more NZP CSI-RS resources or the second group of one or more NZP CSI-RS resources is identified by an index included in each NZP CSI-RS resource configuration.

17. The method of claim 15, wherein the index is one of:
an index of a transmission configuration indicator, TCI, or
a Control Resource Pool Index, or
a new group index.

18. The method of claim 1, wherein the list of NZP CSI-RS resource tuples is contained in a single NZP CSI-RS resource set.

19. The method of claim 1, wherein selecting the first NZP CSI-resource and/or the second NZP CSI-RS resource comprises selecting the first NZP CSI-resource and/or the second NZP CSI-RS resource based on a predetermined metric.

20. The method of claim 19, wherein the metric is downlink throughput.

21. The method of claim 1, wherein the CSI based on the selected first and/or second NZP CSI-RS resource(s) comprises:
a. a rank indicator, RI, for each selected NZP CSI-RS resource;
b. a precoding matrix indicator, PMI, for each selected NZP CSI-RS resource;
c. a channel quality indicator, CQI, for each selected NZP CSI-RS resource;
d. a joint CQI for a pair of selected NZP CSI-RS resources;
e. a layer one reference signal received power, L1-RSRP, for each selected NZP CSI-RS resource;
f. a layer one signal to interference and noise ratio, L1-SINR, for each selected NZP CSI-RS resource;
g. a NZP CSI-RS resource indicator, CRI, for each selected NZP CSI-RS resource;
h. a NZP CSI-RS resource group indicator, CRGI, for each selected NZP CSI-RS resource;
i. a NZP CSI-RS tuple indicator for a selected NZP CSI-RS tuple; or
j. any combination of two or more of (a)-(i).

22. The method of claim 1, wherein selecting the first NZP CSI-RS resource and/or the second NZP CSI-RS resources comprises selecting the first NZP CSI-RS resource and the second NZP CSI-RS resource, and the CSI based on the selected first and second NZP CSI-RS resources comprises a first and a second NZP CSI-RS resource indicator, and associated respectively a first and a second rank indicator, a first and a second precoding matrix indicator, and a joint channel quality indicator, CQI.

23. The method of claim 1, wherein selecting the first NZP CSI-RS resource and/or the second NZP CSI-RS resources comprises selecting the first NZP CSI-RS resource and the second NZP CSI-RS resource, and the CSI based on the selected first and second NZP CSI-RS resources comprises a first and a second NZP CSI-RS resource indicator, and associated respectively a first and a second rank indicator, a first and a second precoding matrix indicator, and a first and a second channel quality indicator.

24. The method of claim 22, wherein the CSI is calculated assuming non-coherent joint transmission, NC-JT, of a physical downlink shared channel, PDSCH, over antenna ports of the first and the second NZP CSI-RS resources on a same time and frequency resource.

25. The method of claim 1, wherein selecting the first NZP CSI-RS resource and/or the second NZP CSI-RS resources comprises selecting the first NZP CSI-RS resource and the second NZP CSI-RS resource, and the CSI based on the selected first and second NZP CSI-RS resource(s) comprises a first and a second NZP CSI-RS resource indicator, and associated respectively a first and a second RSRP or SINR.

26. The method of claim 21, wherein CRI1, CRI2, and/or CRGI are jointly encoded.

27. The method of claim 21, wherein a mapping between a CRI to one or more NZP CSI-RS resources in the first and the second groups of NZP CSI-RS resources, or in the list of NZP CSI-RS tuples, are configured either explicitly or implicitly.

28. The method of claim 21, wherein the indication of the selected one or more NZP CSI-RS resources comprises a RI=0 for the second or the first NZP CSI-RS resource.

29. The method of claim 1, wherein the CSI report configuration further includes a code book configuration.

30. The method of claim 1, wherein the CSI report configuration further includes a report quantity indicator indicating CSI report for Non-Coherent Joint Transmission, NC-JT.

31. The method of claim 1, wherein the report quantity indicator further indicates whether the CSI report includes a joint CQI or a pair of CQIs.

32. The method of claim 1, wherein the CSI report configuration further includes one or more CSI interference measurement, CSI-IM, resources.

33. (canceled)

34. (canceled)

35. A wireless communication device for reporting Channel State Information, CSI, in a wireless network, the wireless communication device comprising:
one or more transmitters;
one or more receivers; and
processing circuitry associated with the one or more transmitters and the one or more receivers, the processing circuitry configured to cause the wireless communication device to:
receive a CSI report configuration that comprises either:
a first group of one or more Non-Zero Power CSI reference signal, NZP CSI-RS, resources for channel measurement and a second group of one or more NZP CSI-RS resources for channel measurement; or
a list of NZP CSI-RS resource tuples each comprising one or more NZP CSI-RS resources for channel measurement; and
select a first NZP CSI-RS resource and/or a second NZP CSI-RS resource in the first group of one or more NZP CSI-RS resources and/or the second group of NZP CSI-RS resources, respectively, or in a NZP CSI-RS resource tuple out of the list of NZP CSI-RS resource tuples; and
report, to a network node, information comprising CSI based on the selected first and/or second NZP CSI-RS resource(s).

36. (canceled)

37. A method performed by a network node, the method comprising:
providing, to a wireless communication device, a CSI report configuration that comprises either:
a first group of one or more Non-Zero Power CSI reference signal, NZP CSI-RS, resources for channel measurement and a second group of one or more NZP CSI-RS resources for channel measurement; or
a list of NZP CSI-RS resource tuples each comprises one or more NZP CSI-RS resources for channel measurement; and
receiving, from the wireless communication device, information comprising CSI based on a selected one or more NZP CSI-RS resources.

38-59. (canceled)

60. A network node comprising processing circuitry configured to causes the network nod to:
provide, to a wireless communication device, a CSI report configuration that comprises either:
a first group of one or more Non-Zero Power CSI reference signal, NZP CSI-RS, resources for channel measurement and a second group of one or more NZP CSI-RS resources for channel measurement; or
a list of NZP CSI-RS resource tuples each comprises one or more NZP CSI-RS resources for channel measurement; and
receive, from the wireless communication device, information comprising CSI based on a selected one or more NZP CSI-RS resources.

61. (canceled)
